(19) United States
(12) Patent Application Publication
(10) Pub. No.: US 2020/0160243 A1
(43) Pub. Date: May 21, 2020

(54) RESOURCE RESERVATION SYSTEM, INFORMATION DISPLAY METHOD, SERVER SYSTEM, AND INFORMATION PROCESSING TERMINAL

(71) Applicant: Ryoh TOMOSUGI, Kanagawa (JP)

(72) Inventor: Ryoh TOMOSUGI, Kanagawa (JP)

(73) Assignee: Ricoh Company, Ltd., Tokyo (JP)

(21) Appl. No.: 16/575,863

(22) Filed: Sep. 19, 2019

(30) Foreign Application Priority Data
Nov. 16, 2018 (JP) 2018-216043
Nov. 16, 2018 (JP) 2018-216045
Jun. 28, 2019 (JP) 2019-122459

(51) Int. Cl. G06Q 10/06; G06Q 10/02; G06Q 10/10

(52) U.S. Cl. CPC G06Q 10/06311; G06Q 10/1095; G06Q 10/02

(57) ABSTRACT

A resource reservation system includes a hardware server including at least one information processing apparatus that stores reservation information concerning at least one resource; and a hardware information processing terminal that acquires and displays the reservation information from the hardware server, wherein the hardware information processing terminal is installed for each of the at least one resource and displays a display content of the reservation information modified in accordance with setup information that sets a display method for displaying the reservation information.

### CROSS-REFERENCE TO RELATED APPLICATIONS

This application is based on and claims priority to Japanese Patent Application No. 2018-216043, filed on Nov. 16, 2018, Japanese Patent Application No. 2018-216045, filed on Nov. 16, 2018, and Japanese Patent Application No. 2019-122459, filed on Jun. 28, 2019, the entire contents of which are incorporated herein by reference.

### BACKGROUND OF THE INVENTION

### 1. Field of the Invention

The present invention relates to a resource reservation system, an information display method, a server system, and an information processing terminal.

### 2. Description of the Related Art

A resource reservation system that accepts reservations for resources such as meeting rooms is known. A reservation person who reserves the meeting room can have the terminal device communicate with the reservation management server and reserve the meeting room in a browser operating on the terminal device.

The meeting room has an information processing terminal, such as a meeting room terminal, which communicates with the meeting management server. The information processing terminal can display the reservation information received from the meeting management server on the standby screen (see, for example, Patent Document 1). Patent Document 1 discloses a system in which a meeting management server transmits an entry application screen information for allowing the use of a meeting room reserved for a floor monitor or the like located in a floor of a meeting room, and a floor monitor or the like displays the meeting room reservation information.

Patent Document 1: Japanese Laid-Open Patent Publication No. 2013-020368

### SUMMARY OF THE INVENTION

The present invention provides a resource reservation system including a hardware server including at least one information processing apparatus that stores reservation information concerning at least one resource; and a hardware information processing terminal that acquires and displays the reservation information from the hardware server, wherein the hardware information processing terminal is installed for each of the at least one resource and displays a display content of the reservation information modified in accordance with setup information that sets a display method for displaying the reservation information.

### BRIEF DESCRIPTION OF THE DRAWINGS

FIG. 1 illustrates an example of a schematic overall operation of a resource reservation system.

FIGS. 2A and 2B illustrate examples of a standby screen displayed by a meeting room terminal.

FIG. 3 is a system configuration diagram of an example of the resource reservation system.

FIG. 4 is a hardware configuration diagram of an example of a meeting management server.

FIGS. 5A and 5B are hardware configuration diagrams of examples of a meeting room terminal.

FIG. 6 is a functional block diagram of an example of a function of a reservation management server, a chat server, a meeting management server, and a registration terminal illustrated in a block shape.

FIG. 7 is a functional block diagram of an example of functions of a terminal device and a meeting room terminal illustrated in a block shape.

FIG. 8 illustrates an example of a reservation setup screen displayed by the terminal device.

FIG. 9 illustrates an example of a non-disclosure information management screen displayed by a registration terminal.

FIG. 10 illustrates an example of a non-disclosure setup management screen displayed by the registration terminal.

FIG. 11 illustrates an example of a non-disclosure setup edit screen displayed by the registration terminal.

FIG. 12 is a sequence diagram illustrating an example in which the reservation information displayed by the meeting room terminal on the standby screen is made non-disclosure.

FIG. 13 illustrates an example of the meeting management information that is transmitted by the meeting management server to the meeting room terminal.

FIG. 14 is a flowchart illustrating an example of a procedure in which the meeting room terminal displays the reservation information on the standby screen.

FIG. 15 is a functional block diagram of an example of a function of a reservation management server, a chat server, the meeting management server, and the registration terminal illustrated in a block shape (second embodiment).

FIG. 16 is a functional block diagram of an example of a function of a terminal device and a meeting room terminal illustrated in a block shape (second embodiment).

FIG. 17 illustrates an example of a non-disclosure information management screen displayed by the meeting room terminal.

FIG. 18 illustrates an example of a non-disclosure setup management screen displayed by the meeting room terminal.

FIG. 19 illustrates an example of a non-disclosure setup edit screen displayed by the meeting room terminal.

FIG. 20 is a sequence diagram illustrating an example of a procedure in which the reservation information displayed by the meeting room terminal on the standby screen is made non-disclosure.

FIGS. 21A and 21B illustrate an example of an operation of making an arbitrary item of the reservation information non-disclosure.

FIG. 22 is a functional block diagram of an example of functions of the reservation management server, the chat server, the meeting management server, and the registration terminal illustrated in a block pattern (third embodiment).

FIG. 23 is a sequence diagram illustrating an example of a procedure in which the reservation information displayed by the meeting room terminal on the standby screen is made non-disclosure (third embodiment).

### DETAILED DESCRIPTION OF THE PREFERRED EMBODIMENTS

However, there is a problem that the information displayed by the information processing terminal cannot be changed in the conventional resource reservation system.

That is, the information processing terminal is installed in the meeting room, at the entrance of the meeting room, or near the meeting room, and in order to receive check-in or check-out to the meeting room, or to display the reservation status of the meeting room, a person who moves near the meeting room terminal can view the meeting name, the participant name, or the like.

However, the meeting name may include the company's policies and negotiation content, and the participant name may include a key person, business partner or negotiating partner.

Said differently, the reservation information displayed by the information processing terminal on the standby screen may indicate important information of the company, and there was a risk that important information could unintentionally be leaked.

In view of the above-described problem, the present invention is intended to provide a resource reservation system capable of changing at least a part of the information displayed by an information processing terminal.

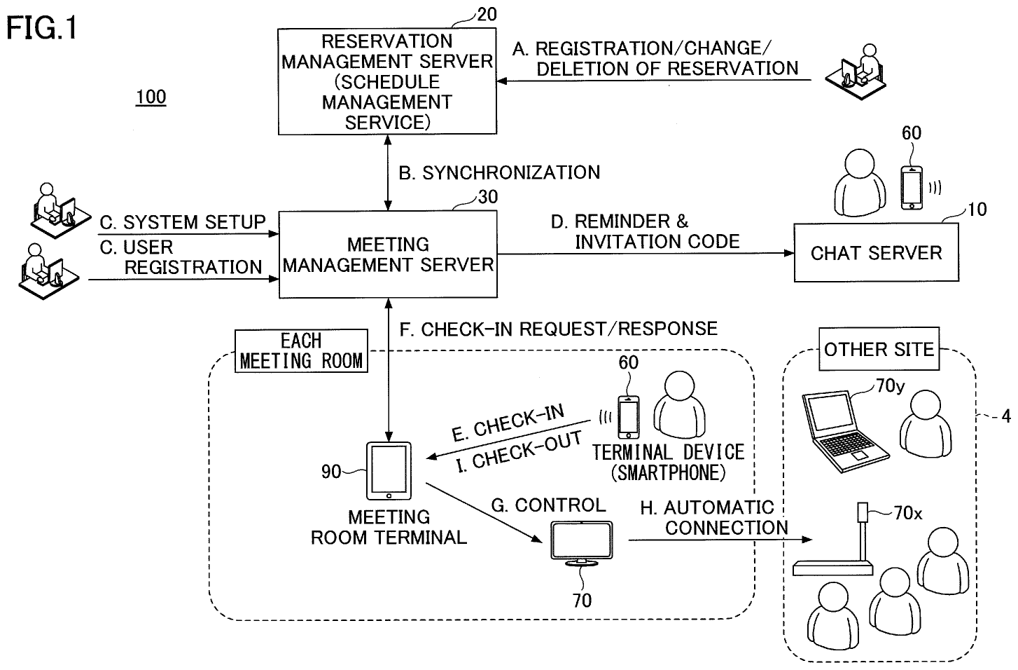

A description is given below, with reference to the FIG. 1 through FIG. 23 of embodiments of the present invention. Where the same reference symbols are attached to the same parts, repeated description of the parts is omitted.

Reference symbols typically designate as follows:
10 Chat server
20 Reservation management server
30 Meeting management server
60 Terminal device
70 Electronic apparatus
90 Meeting room terminal
100 Resource reservation system

Hereinafter, as an example of an embodiment of the present invention, a resource reservation system and an information display method performed by the resource reservation system will be described with reference to the figures.

### <Overview of Resource Reservation System>

First, the reservation system is described with reference to FIG. 1. FIG. 1 is an example of a diagram illustrating the overall operation of the resource reservation system 100.

(A) The reservation person operates his/her terminal device 60 to communicate with the reservation management server 20 and reserve a meeting room. The reservation management server 20 is a general-purpose cloud service (Office 365, G Suite (“Office 365” and “G Suite” are registered trademarks), etc.), and a meeting room owned by an organization such as a company, to which the reservation person belongs, is registered in the reservation management server 20.

(b) A meeting management server 30 is a server that controls the entire resource reservation system 100 based on the reservation state of the meeting room. Because the meeting management server 30 appropriately communicates with the reservation management server 20 to acquire reservation information, the reservation information is synchronized between the reservation management server 20 and the meeting management server 30.

(C) A resource reservation system 100 or an administrator on the organization side can register the user and perform various setups for the meeting management server 30. User registration means the registration of a user object to various notifications using chat server 10 (Slack, Line, Microsoft Teams (“Slack”, “Line”, and “Microsoft Teams” are registered trademarks), etc.). Because the notification is performed by a bot sending a message as the meeting management server 30, the bot provided by a chat server is also registered. The various setups include registering the meeting room terminal 90 and setup the timing of reminders.

(D) The meeting management server 30 reminds the reservation person at a predetermined time prior to the opening time of the meeting in the reservation information. This will reduce the number of empty reservations of the meeting rooms. The meeting management server 30 notifies the user of an invitation code (invitation to a group) as necessary. The reservation person who reserves the meeting stores information (meeting identification information) for checking in the meeting room in the terminal device 60 by receiving a reminder. Checking in the meeting room means starting to use the meeting room.

(E) Each of the meeting rooms 6 has a meeting room terminal 90, and the meeting room terminal 90 downloads information about meetings prospected to be held in this meeting room on a regular basis. The meeting room terminal 90 may display a prospect for the day or the latest meeting to allow the participant to confirm the prospect of the meeting. Shortly before the start of the meeting, the reservation person who reserves the meeting room goes to meeting room 6 and checks in. For example, the meeting room terminal 90 may be inputted with the meeting room information, or the terminal device 60 may be brought closer to the meeting room terminal 90 (e.g., the meeting room information is caused to be read or communicated).

(F) Because the meeting room terminal 90 transmits a check-in request to the meeting management server 30, if the check-in can be authenticated by the meeting identification information, a response indicating that the check-in can be completed is received from the meeting management server 30. The meeting room terminal 90 indicates that it is in use (during the meeting). If it is impossible to confirm the use start notice notifying the check-in to the start time of the meeting, the meeting management server 30 cancels the reservation of the meeting room 6 (cancels the reservation information when the meeting room is not used for a predetermined time) and transmits the cancelled status contained in the reservation information to the meeting room terminal 90. In this case, because the meeting room terminal 90 indicates that it is a vacant room, any user can use the meeting room 6.

The G. Meeting Room terminal 90 controls the electronic apparatus 70 upon request from the Meeting Management Server 30. For example, turn on the power at the start time of the meeting and turn off the power at the end time of the meeting. This will improve the convenience of meeting participants in operating an electronic apparatus 70.

(H) The electronic apparatus 70 has a teleconference function, for example, it can communicate with the electronic apparatus (e.g., the teleconference terminal 70x) of the other site 4 and hold a meeting with the other site. Further, a PC 70y, in which the app operates, can communicate with the electronic apparatus 70. The reservation information includes the destination information (the communication ID of the destination) representing the other site 4 in advance, and the electronic apparatus 70 can communicate with the teleconference terminal 70x and the PC 70y automatically.

(I) When the reservation person ends the meeting, the button of the meeting room terminal 90 is pressed to check out, so the meeting room terminal 90 displays a reservation status as follows. This allows an arbitrary user to know the reservation status of the meeting room.

### First Embodiment

<Example of Standby Screen of this Embodiment>

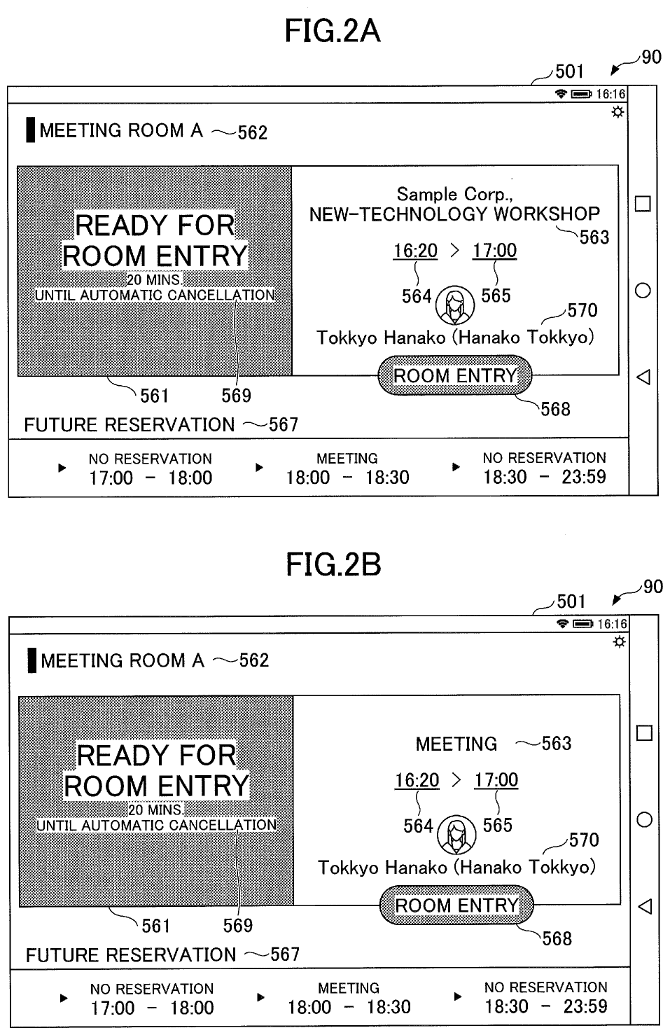

FIGS. 2A and 2B illustrate examples of the standby screen 501 displayed by the meeting room terminal 90. FIG. 2A illustrates a standby screen 501 before the non-disclosure information illustrated for comparison is made non-disclosure. Details of the standby screen 501 will be described later. In the standby screen 501 illustrated in FIG. 2A, the name of the meeting is displayed as “Sample corp., New-technology workshop” as a meeting name field 563. This meeting name field 563 contains the company name and the meeting content and may unintentionally leak important information.

Therefore, in the resource reservation system 100 according to this embodiment, the predetermined non-disclosure information is made non-disclosure by the meeting room terminal 90. FIG. 2B illustrates a standby screen 501 on which non-disclosure information has been made non-disclosure. Referring to FIG. 2B, the meeting name field 563 displays “Meeting”. In comparison with FIG. 2A, the company name and the content of the meeting are made non-disclosure, which reduces the risk of leakage of important information.

Specifically, the resource reservation system 100 according to this embodiment can set the issue of non-disclosure to the reservation information when the reservation person reserves the meeting room to the reservation management server 20. In addition, non-disclosure information is registered in the meeting management server 30. For example, assume that non-disclosure information such as “HQ” is registered.

When the reservation person reserves the meeting room under a meeting name “meeting to determine the policy of the Head Office”, the meeting management server 30 sets the reservation information to non-disclosure so that the content are not leaked to a third party. However, the meeting management server 30 has an operation mode that makes the items non-disclosure, even if the reservation person forgets to set a non-disclosure target items to be non-disclosure.

When the non-disclosure setup is made, the meeting management server 30 sets the item of reservation information containing the non-disclosure information “Head Office” to be non-disclosure and transmits the reservation information to the meeting room terminal 90. More specifically, the meeting management server 30 designates an item (a non-disclosure target item) making the non-disclosure information non-disclosure (a non-disclosure target item) for each non-disclosure information, and a non-disclosure target item associated with the “Head Office” is made non-disclosure. At least a part of the reservation information is sufficient to be non-disclosure.

Because the meeting room terminal 90 makes the non-disclosure target item non-disclosure on the standby screen 501, it is possible to prevent to prevent leakage to a third party of the fact that a “meeting to determine the policy of the Head Office” is held in the meeting room.

### <Terminology>

The resources represent stocks. The meeting room and equipment, devices, people (reception) and structure that can be used in the meeting room represent the resources. A part of the resources that is difficult to move is called facility. For convenience of explanation, the term, namely, “meeting room” is used in this embodiment as an example of the resources.

The reservation person is the person who reserved the meeting room, and the participant is the person who attends the meeting. The reservation person is often included in the participant but may not be included. In this embodiment, the work performed by the reservation person may be performed by the participant. All persons who use meeting rooms are simply called users.

Setup information refers to information on changes to the display of reservation information. It includes the issue that the reservation information is changed. It may also include how the changes will be made. For example, making non-display or using fixed notation may be contained in the setup information. Information about an object to be made non-display may also be contained.

The display content of the reservation information is a content in a case where the reservation information is displayed. The display content is not required to be the whole of the reservation information but a part of the reservation information to be displayed.

### <Example of System Configuration>

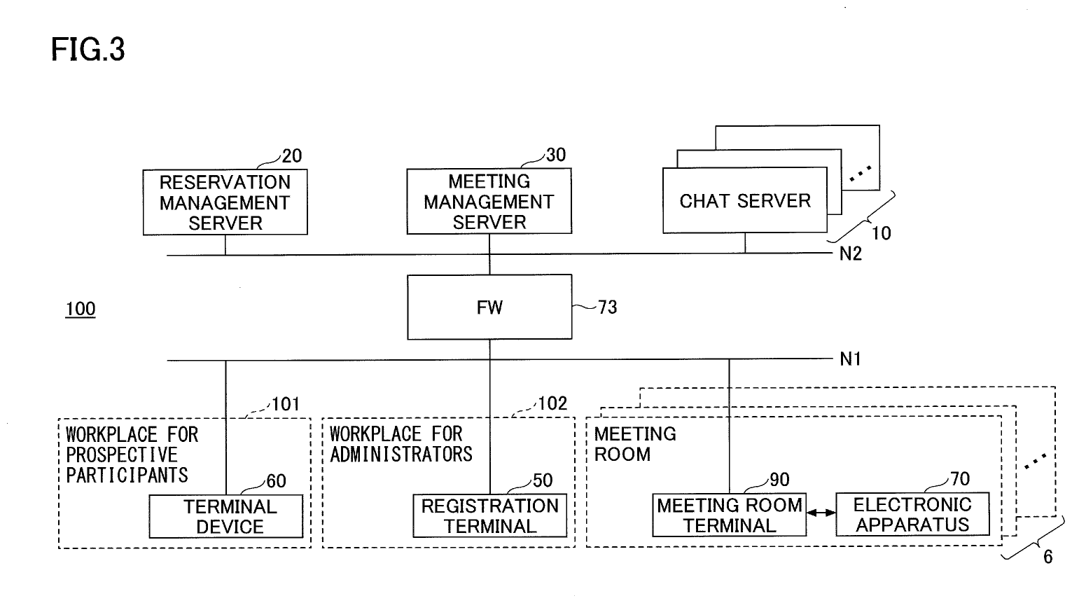

FIG. 3 illustrates an example of a system configuration of the resource reservation system 100. The resource reservation system 100 may be divided into an external network N2 and an internal network N1. The internal network N1 is a network inside the firewall 73, and the external network N2 is a network such as the Internet where an unspecified great number of communications is transmitted.

The reservation management server 20, the meeting management server 30, and one or more of the chat servers 10 are connected to the external network N2, and each server can communicate as needed. The external network N2 may be connected to the terminal device 60 operated by a participant in the meeting as needed.

The reservation management server 20 is implemented by one or more information processing apparatuses (computer systems) on which a typical server OS or the like is mounted. The system related to the reservation of a facility provided by the reservation management server 20 is referred to as the reservation management system. The reservation management server 20 has a calendar system and provides a web application for managing various prospects. Specifically, it has the following functions:

Receipt of a scheduled registration and optional confirmation by the reservation person;

Notification by email at the set date and time, such as 30 minutes before the set date;

One person can manage prospects in multiple calendars (for work, home, etc.); and

Share calendars with people in the same group.

The reservation management server 20 manages the user using an account. An account is a user's right to use the service. In many systems, the user logs into the system using an account. For this reason, the account has a function (an identification information function) that uniquely identifies the user of the system.

According to this embodiment, the reservation management server 20 transmits the reservation information of the previously registered account (domain) to the meeting management server 30. Alternatively, when the meeting management server 30 requests the reservation information by specifying the account of the reservation management server 20, the meeting management server 30 can acquire the reservation information of the meeting room 6 from the reservation management server 20. The account may be information that uniquely identifies the user, for example, e-mail, ID, telephone number, or the like.

According to this embodiment, the reservation of the meeting room 6 is managed as a prospect. However, the reservation management server 20 can manage various prospects without limiting to the meeting room 6. In addition to the meeting room 6, it can be used for reservation oudios, rental cycles, rental cars, lodging facilities such as hotels, and rental spaces such as event venues and lockers.

As the reservation management system, G Suite (“G Suite” is a registered trademark), Office 365 (“Office 365” is a registered trademark), and the like are known. However, it is sufficient that the reservation management system having the function described in this embodiment.

Further, in this embodiment, information concerning the meeting room 6 of the internal network Ni is previously registered in the reservation management server 20. That is, the web application of the reservation management server 20 is customized according to the meeting room name of each meeting room 6, the meeting room ID, the available reservation time, the capacity of each meeting room 6, and the reservation unit in the corporate network using the resource reservation system 100. Accordingly, the reservation information is associated with a meeting room 6 of an enterprise utilizing the resource reservation system 100.

The chat server 10 may be implemented by one or more information processing apparatuses (computer systems) having a typical server OS or the like. The chat system is a real-time sharing system for information such as text, audio, video and the like among a plurality of users provided by the chat server 10. The chat server 10 notifies the terminal device 60 of the information related to the reservation of the meeting room 6. In this embodiment, multiple chat servers 10 having different operating entities may be included.

The shared information contains images, audio, etc., and is not limited to text. However, for the sake of convenience of explanation, this embodiment explains that text is mainly used for the notification. For example, the chat system may provide a voice communication function between groups. A voice call may be one-to-one or one-to-N (≥2). Accordingly, in this embodiment, when the chat system notifies the information regarding the reservation of the meeting room 6, it may output an audio message as well as a text display. The chat system is known as LINE (“LINE” is a registered trademark; hereinafter abbreviated), Slack (“Slack” is a registered trademark), and Microsoft Teams (“Microsoft Teams” is a registered trademark; hereinafter abbreviated). However, the chat system can notify one or more users using a bot (a program that performs a predetermined process).

The chat server 10 similarly manages the user with an account (different from the account of the reservation management server 20). In principle, the meeting management server 30 does not need to be aware of the account of the chat server 10. However, the meeting management server 30 may designate and notify an arbitrary account of the chat server 10.

The meeting management server 30 can be implemented by one or more information processing apparatuses (computer systems) having an ordinary server OS or the like. As a process related to the external network N2, the meeting management server 30 acquires the reservation information of the meeting room 6 from the reservation management server 20, acquires the prospective participant set as the reservation information, and transmits a notification to a group (or an individual person such as a reservation person) of the chat server 10 associated with the prospective participant at a predetermined time.

Further, as the process related to the in-house network N1, the check-in and the check-out to the meeting room 6 are managed, and the power supply of the electronic apparatus 70 is controlled based on the reservation information of the meeting room 6 obtained from the reservation management server 20.

The meeting management server 30 and the reservation management server 20 may be provided as one server or service, and the system having a plurality of such servers is referred to as a server system.

The internal network N1 has a meeting room 6, a workplace 101 for prospective participants, and a workplace 102 for administrators. Prospective participants can access the external network N2 from various locations through the internal network N1. The internal network N1 is, for example, a local area network (LAN). The meeting room 6, the workplace 101 for prospective participant, and the workplace 102 for administrator are not necessarily a LAN within the same company.

A meeting room terminal 90 and an electronic apparatus 70 are disposed in the meeting room 6. The meeting room terminal 90 and the electronic apparatus 70 may communicate over a small LAN or dedicated line. The electronic apparatus can be connected to the internal network N1 and the external network N2 without going through the meeting room terminal 90. The meeting room terminal 90 and electronic apparatus 70 may communicate using a wired or wireless communication. Because the internal network N1 is present inside the firewall 73, direct communication from the external network N2 to the internal network N1 is difficult.

The meeting room terminal 90 is an information processing terminal operated by the participant of the meeting such as the reservation person who uses the meeting room 6. The meeting room terminal 90 is provided on the desk of the meeting room 6 or at the entrance of the meeting room 6. A plurality of meeting room terminals 90 may be provided in one meeting room 6. The meeting room terminal 90 can be implemented by one or more information processing apparatuses (computer systems) having a typical OS or the like.

The meeting room terminal 90 transmits the meeting room ID to the meeting management server 30 and displays the reservation information of the meeting room 6 on the day. In addition, the reservation information is requested periodically to obtain the reservation information that has been changed. Further, the control information such as the power ON and OFF of the electronic apparatus 70 is acquired from the meeting management server 30. Thus, the meeting room terminal 90 turns ON and OFF the power of the electronic apparatus 70.

The meeting room terminal 90 displays the standby screen 501 for checking in, checkout, or the like, and communicates with the meeting management server 30 for informing the meeting management server 30 of the check-in or check-out. At the time of checking in, the meeting room terminal 90 transmits the meeting identification information input from the reservation person and the meeting room ID stored in advance to the meeting management server 30. Therefore, the meeting management server 30 can confirm that the meeting room 6 reserved by the reservation person who reserved the meeting room 6 is used based on the meeting identification information and the meeting room ID.

The electronic apparatus 70 are a variety of office apparatuses that may be used in the meeting room 6. Examples include electronic chalkboards, multifunction peripherals projectors, digital signage, digital cameras, and the like. The electronic blackboard has a large display with a touch panel, detects the coordinates of the panel indicated by the user, connects the coordinates, and displays stroke. In addition, the image of the connected PC can be displayed, and the stroke can be synchronized by communicating with the electronic blackboard of other sites. The electronic blackboard is sometimes called an electronic information board or an electronic whiteboard.

The multifunction peripheral has functions of a copier, scanner, printer, and facsimile transmission/reception, and is used for printing materials during meetings, copying materials, digitizing materials, and transmitting materials. The projector is an apparatus for projecting images. For example, the terminal device 60 can share the image displayed on the display by projecting the image on the screen or the like among the participants. A digital signage is a large display and is used to display any still image or movie. The digital cameras are used by each participant to capture and store paper material or material displayed on the electronic blackboard.

A terminal device 60 capable of connecting to the internal network N1 is disposed in the workplace 101 for the prospective participants. The terminal device 60 may communicate by wire or wirelessly. The terminal device 60 is an information processing apparatus used by a prospective participant (including a reservation person) when reserving a meeting room, but it is also assumed that the terminal device 60 is brought into the meeting room. Information processing equipment carried by prospective participants.

The terminal device 60 can be implemented by one or more information processing apparatuses (computer systems) having a typical OS or the like. The terminal device 60 may be, for example, a smartphone, a tablet terminal, a PC (Personal Computer), a PDA (Personal Digital Assistant), a wearable PC (sunglasses, wristwatches, etc.), or the like. However, the browser software having the communication function or the application software dedicated to the chat server 10 or the reservation management server 20 may operate. For example, a car navigation system, a game machine, a television set, or the like may also be the terminal device 60.

In the terminal device 60, application software (hereinafter, referred to as “chat application”) dedicated to the chat server 10 is operated, and application software dedicated to the resource reservation system 100 (hereinafter, referred to as “meeting application”) is also operated. However, these may be substituted with browser software.

The registration terminal 50 that can be connected to the internal network N1 is disposed to the workplace 102 for administrator. The registration terminal 50 may communicate by wire or wirelessly. The registration terminal 50 is a terminal for the administrator to perform various setups in the meeting management server 30.

The registration terminal 50 may be an information processing apparatus similar to the terminal device 60. However, because the registration terminal is mainly used by the administrator to set in the meeting management server 30, there may be neither chat application nor meeting application. The registration terminal 50 communicates with the meeting management server 30 mainly by browser software and displays a web page.

### <Hardware Configuration>

### <<Hardware Configuration of the Meeting Management Server>>

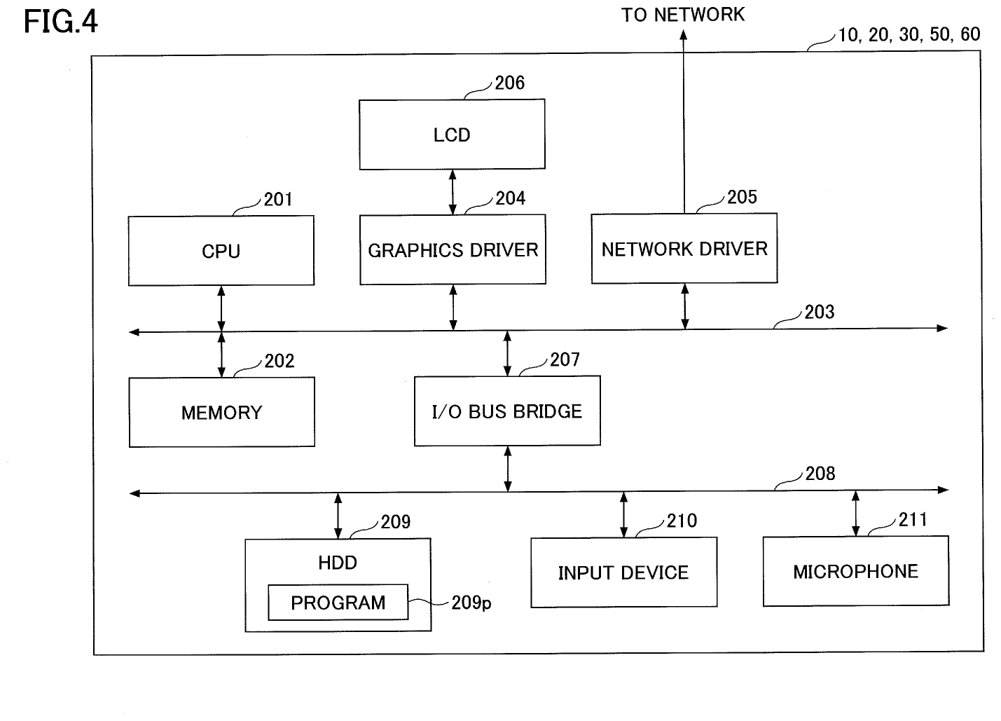

FIG. 4 illustrates an example of a hardware configuration of the meeting management server 30. This exemplifies the schematic hardware configuration of the meeting management server 30. The meeting management server 30 includes a CPU 201 and a memory 202 that enables fast access to data used by the CPU 201. The CPU 201 and memory 202 are connected through a system bus 203 to another device or driver of the meeting management server 30, such as a graphics driver 204 and network driver (NIC) 205.

The graphics driver 204 is connected to a LCD (liquid crystal display device, as an example of a display) 206 through a bus to monitor the processing result by the CPU 201. The network driver 205 also connects the meeting management server 30 to the external network N2 at the transport and physical layer levels to establish a session with another device.

The system bus 203 is further connected to an I/O bus bridge 207. A memory device such as a HDD (hard disk drive) 209 is connected to the downstream side of the I/O bus bridge 207 by an IDE, an ATA, an ATAP80I, a serial ATA, a SCSI, a USB, or the like through an I/O bus 208 such as a PCI. The HDD 209 stores a program 209p for controlling the entire meeting management server 30. The HDD 209 may be an SSD (Solid State Drive). The program 209p may be distributed as stored on a memory medium, or it may be delivered from a program delivery server.

An input device 210, such as a keyboard and a mouse (referred to as a pointing device), is connected to the I/O bus 208 through a bus, such as a USB, for receiving inputs and commands from an operator, such as a system administrator.

The hardware configuration of the illustrated meeting management server 30 represents a hardware element preferably provided by the meeting management server 30.

The hardware configuration diagram of the reservation management server 20, the chat server 10, the registration terminal 50, and the terminal device 60 is the same as that of the meeting management server 30, or even though it is different, there is no trouble in describing the resource reservation system 100 of the this embodiment. In addition, because the meeting management server 30, the reservation management server 20, and the chat server 10 correspond to cloud computing, the hardware configurations may be configured such that hardware resource is dynamically connected and disconnected in accordance with the load. Here, the cloud computing is a mode of use in which resources on a network can be used without consideration of specific hardware resources.

### <<Meeting Room Terminal>>

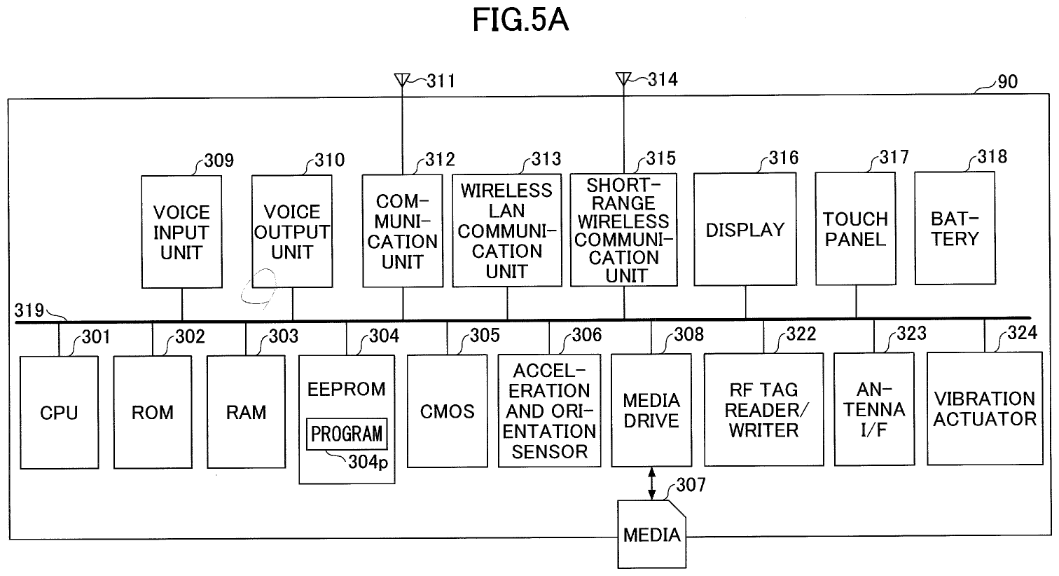

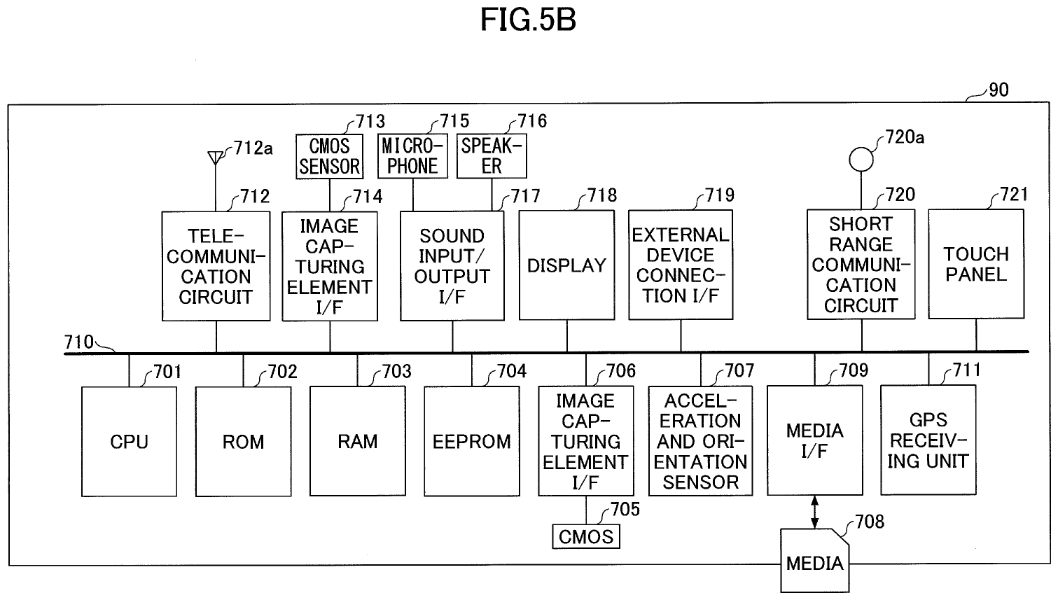

FIGS. 5A and 5B illustrates an example of the hardware configuration of the meeting room terminal 90. Two examples of the hardware configuration of the meeting room terminal 90 are illustrated. Incidentally, the meeting room terminal 90 of FIGS. 5A and 5B is assumed to be a tablet device. The meeting room terminal 90 of FIG. 5A includes a CPU 301, a ROM 302, a RAM 303, an EEPROM 304, a CMOS sensor 305, an acceleration and orientation sensor 306, and a media drive 308.

The CPU 301 controls the overall operation of the meeting room terminal 90. The ROM 302 stores the basic input/output program. RAM 303 is used as the work area of CPU 301. The EEPROM 304 reads or writes data according to the control of the CPU 301. The CMOS sensor 305 captures the object according to the control of the CPU 301 and obtains image data. The acceleration and orientation sensor 306 is an electromagnetic compass, gyrocompass, acceleration sensor, or the like that detects geomagnetic field.

A media drive 308 controls the reading or writing (memory) of data to the media 607, such as flash memory. The media drive 308 is configured to detachably mount the media 607 for storing data read from or newly written from already recorded data.

The program 604p executed by the CPU 301 is stored in the EEPROM 304. The program 604p is application software, an OS, or the like for executing various processes in the embodiment. The program 604p may be distributed as stored in the media 607 or from a program delivery server.

The CMOS sensor 305 is a charge-coupled device that converts light into an electric charge to electronically digitize the image of the object. The CMOS sensor 305 may be, for example, a CCD (Charge Coupled Device) sensor if the image of the object can be captured. The CMOS sensor 305 can read a bar code or two-dimensional bar code.

In addition, meeting room terminal 90 includes an RF tag reader/writer 322, an antenna I/F 323, and a vibration actuator 324. The RF tag reader/writer 322 communicates according to standards such as, for example, NFC (Near Field Communication).

A vibration actuator 324 is a motor that vibrates meeting room terminal 90. For example, when the end of the meeting is approaching, the meeting room terminal 90 vibrates to inform the participant of the end.

The meeting room terminal 90 further includes a voice input unit 309, a voice output unit 310, an antenna 311, a communication unit 312, a wireless LAN communication unit 313, an antenna 314 for near-range wireless communication, a short-range wireless communication unit 315, a display 316, a touch panel 317, and a bus line 319.

The voice input unit 309 converts the voice into a voice signal. The voice output unit 310 converts the voice signal to speech. The communication unit 312 communicates with the nearest base station apparatus by a radio communication signal using an antenna 311. The wireless LAN communication unit 313 performs wireless LAN communication that conforms to the IEEE 802.11 standard.

The short-range wireless communication unit 315 is a communication device that uses a short-range wireless communication antenna 314 and complies with, for example, the communication standard of Bluetooth (“Bluetooth” is a registered trademark) or Bluetooth Low Energy (“Bluetooth Low Energy” is a registered trademark).

The display 316 is liquid crystal or organic EL for displaying an image of the object or various icons. The touch panel 317 is mounted on the display 316 and is comprised of a pressure-sensitive or electrostatic panel to detect a touch position on the display 316 by touching it with a finger, a touch pen or the like. The bus line 319 is an address bus, a data bus, or the like for electrically connecting the above units.

The meeting room terminal 90 also includes a dedicated battery 618, which may be driven by either the battery 618 or a commercial power supply. The voice input unit 309 includes a microphone for inputting voice. A voice output unit 310 includes a speaker for outputting voice.

FIG. 5B illustrates an example of the hardware configuration of the meeting room terminal 90. As illustrated in FIG. 5B, the meeting room terminal 90 includes a CPU 701, a ROM 702, a RAM 703, an EEPROM 704, a CMOS sensor 705, an image capturing element I/F 706, an acceleration and orientation sensor 707, a media I/F 709, and a GPS receiving unit 711.

Among these, the CPU 701 controls the operation of the entire meeting room terminal 90. The ROM 702 stores a program used to drive the CPU 701, such as the CPU 701 and the IPL. RAM 703 is used as the work area of CPU 701. The EEPROM 704 reads or writes various data such as an application according to the control of the CPU 701. The CMOS (Complementary Metal Oxide Semiconductor) sensor 705 is a type of a built-in image capturing means that captures the image of the object (mainly a self image) according to the control of the CPU 701 to obtain image data. It may be an image capturing means, such as a CCD (Charge Coupled Device) sensor, not a CMOS sensor. The image capturing element I/F 706 is a circuit that controls the drive of the CMOS sensor 705. The acceleration and orientation sensor 707 is a variety of sensors, such as an electromagnetic compass, a gyrocompass, and an acceleration sensor, which detect geomagnetic fields. The media I/F 709 controls the reading or writing (memory) of data to a recording medium 708, such as a flash memory. The GPS receiving unit 711 receives the GPS signal from the GPS satellite.

The meeting room terminal 90 includes a telecommunication circuit 712, a CMOS sensor 713, an image capturing element I/F 714, a microphone 715, a speaker 716, a sound input/output I/F 717, a display 718, an external device connection I/F (Interface) 719, a short range communication circuit 720, an antenna 720a of a short range communication circuit 720, and a touch panel 721.

Among these, the telecommunication circuit 712 is a circuit for communicating with other devices through a communication network. The CMOS sensor 713 is a type of built-in image capturing means that captures an object according to the control of the CPU 701 and obtains image data. The image capturing element I/F 714 is a circuit that controls the drive of the CMOS sensor 713. The microphone 715 is a built-in circuit that converts sound to an electrical signal. The speaker 716 is a built-in circuit for generating sound such as music and voice by changing the electric signal into physical vibration. A sound I/O I/F 717 is a circuit that processes the input and output of sound signals between the microphone 715 and the speaker 716 according to the control of the CPU 701. The display 718 is a type of display means such as a liquid crystal or an organic EL (Electro Luminescence) for displaying an image of the object or various icons. The external device connection I/F 719 is an interface for connecting various external devices. The short range communication circuit 720 is a communication circuit such as a Near Field Communication (NFC) or Bluetooth (“Bluetooth” is a registered trademark). The touch panel 721 is a type of input means for operating the meeting room terminal 90 by a user pressing the display 718.

The meeting room terminal 90 also includes a bus line 710. The bus line 710 is an address bus, data bus, or the like for electrically connecting components such as the CPU 701 illustrated in FIG. 4.

### <Function>

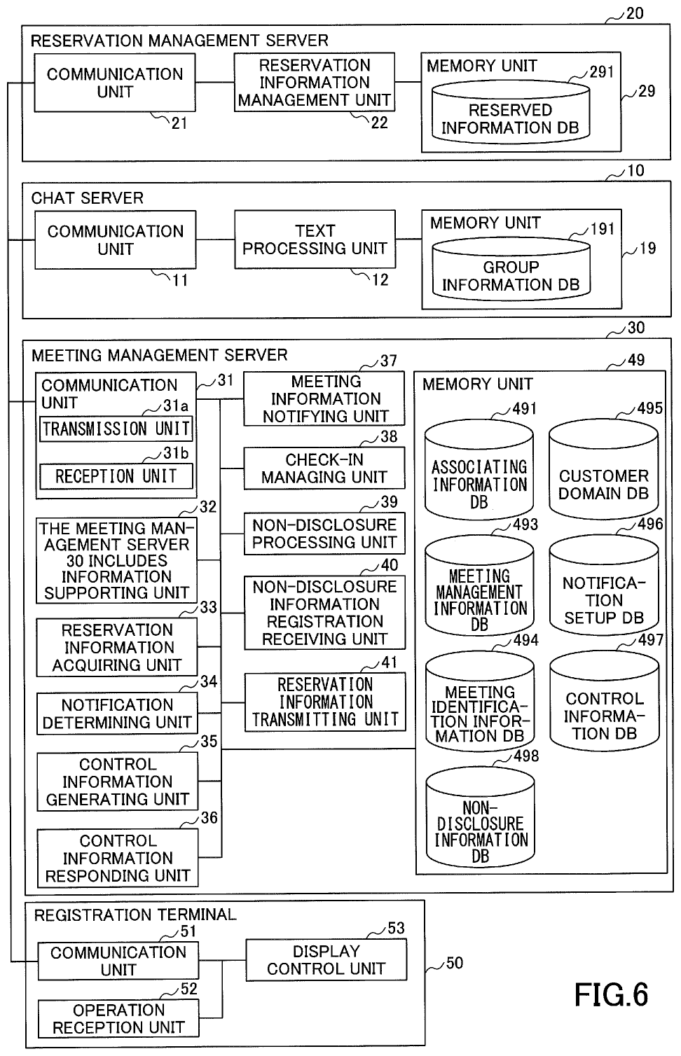

FIG. 6 is a functional block diagram illustrating an example of the functions of the reservation management server 20, the chat server 10, the meeting management server 30, and the registration terminal 50 in a block shape.

### <<Reservation Management Server>>

The reservation management server 20 includes a communication unit 21 and a reservation information management unit 22. Each of the functional units provided by the reservation management server 20 is a function or means that is implemented by one of the components illustrated in FIG. 4 being operated by a command from the CPU 201 according to the program 209p expanded from the HDD 209 to the memory 202.

The communication unit 21 transmits and receives various information with the meeting management server 30 and the terminal device 60. The communication unit 21 transmits screen information of the reservation setup screen to the terminal device 60 and receives the reservation setup from the terminal device 60. The reservation information is transmitted to the meeting management server 30.

The reservation information management unit 22 is a general web server (web application) that receives reservation information, and further manages reservation information registered by a user. When the reservation information is registered (or changed), the reservation information management unit 22 notifies the meeting management server 30 of the account of the reservation person and transmits the reservation information to the meeting management server 30 through the communication unit 21 in response to a request for designating an account from the meeting management server 30. The reservation information that has been changed without a request may be transmitted to the meeting management server 30. A typical web application is to be used as the method by which the reservation management server 20 reserves the meeting room 6.

The reservation management server 20 includes a memory unit 29. The memory unit 29 is implemented by the memory 202 and the HDD 209 of FIG. 4. A reservation information DB 291 (Data Base) is stored in the memory unit 29.

TABLE 1
RESERVATION INFORMATION DB

| | RESERVATION | | | START | END | PROSPECTIVE | NON- |
|---|---|---|---|---|---|---|---|
| RESERVATION | PERSON | MEETING | MEETING | DATE AND | DATE AND | PARTICIPANT | DISCLOSURE |
| ID | ACCOUNT | NAME | ROOM ID | TIME | TIME | ACCOUNT | FLAG |
| 001 | a@xfood.com | MEETING ABOUT | K-001 | 2017 Jul. 7 | 2017 Jul. 7 | b@xfood.com | ON |
| | | AUTOMATED | | 10:00 | 12:00 | c@xfood.com | |
| | | DRIVING | | | | d@xfood.com | |
| | | WITH | | | | | |
| | | Sample | | | | | |
| | | Corp. | | | | | |
| 002 | e@xfood.com | DEVELOPMENT | K-001 | 2017 Jul. 7 | 2017 Jul. 7 | f@xfood.com | OFF |
| | | OF COMMERCIAL | | 13:00 | 14:00 | g@xfood.com | |
| | | PRODUCTY | | | | | |
| . . . | . . . | . . . | . . . | . . . | . . . | . . . | . . . |

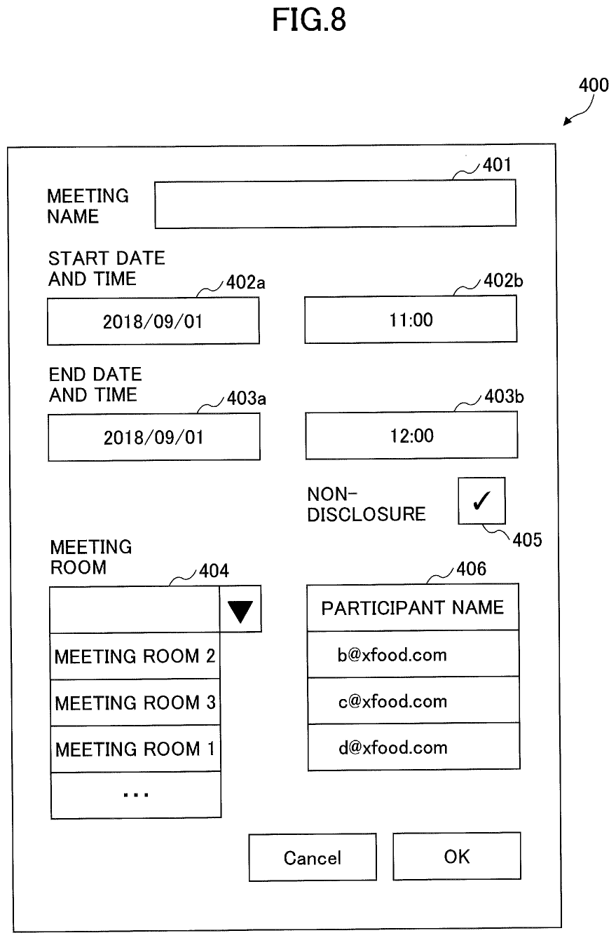

Table 1 illustrates an example of reservation information stored in the reservation information DB 291. The reservation information is information to manage the reservation status of the meeting room 6. The reservation information contains a reservation person account, meeting name, meeting room ID, start time, end time, prospective participant account, and non-disclosure flag items corresponding to the reservation ID. The reservation ID is identification information that identifies one record of reservation information. The ID stands for identification and means an identifier or identification information. The ID is a name, code, character string, numeric value, or one or more of these combinations used to uniquely distinguish a particular object from multiple objects. The same applies to IDs other than reservation ID. The reservation person account is the account of the prospective participant who reserved the meeting room 6. The name of the meeting is the name given to the prospective participant voluntarily. The meeting room ID is the identification information identifying the meeting room 6 in the internal network. The start time is the start time of the reserved meeting room 6 (the start time of the meeting), and end time is the end time of the reserved meeting room 6 (the end time of the meeting). The prospective participant account is the account of the prospective participant who is prospected to attend the meeting. All of the accounts in Table 1 are accounts issued by the reservation management server 20. The non-disclosure flag is the setup of whether the reservation information set by the reservation person at the time of registration of the reservation information is not to be disclosed (“non-disclosure setup field” in FIG. 8).

### <<Chat Server>>

The chat server 10 includes a communication unit 11 and a text processing unit 12. Each of these functional units of the chat server 10 is a function or means in which each of the configuration categories illustrated in FIG. 4 is implemented by operating in accordance with a command from the CPU 201 in accordance with the program 209p expanded from the HDD 209 to the memory 202.

The communication unit 11 transmits and receives various information from the meeting management server 30. In this embodiment, information about the meeting room reservation, information identifying a bot (e.g., a token), and information identifying a notified group are received from the meeting management server 30. The information identifying the bot is notified in advance by the chat server 10 as the bot identification information when the bot of the meeting management server 30 is created. In addition, an individual account, such as a reservation person, may be specified. The communication unit 11 transmits the response of the prospective participant to the meeting management server 30 in response to the fact that the prospective participant has read the information concerning the meeting room reservation or the information concerning the displayed meeting room reservation.

The text processing unit 12 transmits the reservation information of the meeting room 6 to the prospective participants belonging to the group based on the information identifying the bot notified from the meeting management server 30 and the information identifying the group to which the notification is made. Notifications may be made only for the number of prospective participants or only for the subscribers or notified users.

The text processing unit 12 can provide a so-called push notification. Push notifications shall be made using the well-known mechanism provided by each operating system.

The chat server 10 includes a memory unit 19. The memory unit 19 is implemented by the memory 202 and the HDD 209 of FIG. 4. The group information DB 191 is stored in the memory unit 19.

TABLE 2
GROUP INFORMATION DB

| | | MEMBER | MEMBER | MEMBER | MEMBER | BOT |
|---|---|---|---|---|---|---|
| WORKSPACE | CHANNEL | ACCOUNT 1 | ACCOUNT 2 | ACCOUNT 3 | ACCOUNT 4 | ACCOUNT |
| http://sample.com/1 | #marketing | a@chat.com | b@chat.com | c@chat.com | d@chat.com | robo@chat.com |
| http://sample.com/2 | #team1 | b@chat.com | d@chat.com | | | |
| http://sample.com/3 | #ip | f@chat.com | g@chat.com | h@chat.com | | robo@chat.com |
| . . . | . . . | . . . | . . . | . . . | . . . | . . . |

Table 2 indicates an example of group information stored in group information DB 191. The group information is information in which the account of members belonging to the same group is registered. The group information includes member accounts 1 to n (n=4 in Table 2) and bot accounts associated with workspaces and channels.

The workspace is identification information to identify an organization such as companies and departments. In this embodiment, more than one member belongs to the workspace (e.g., Company A). The workspace is, for example, a URL, which is sufficient to be unique. In addition, the workspace has a plurality of channels depending on the purpose of the chat and the like. The channel is a group of members for which common information is exchanged, e.g., a group for product A, a group for product B, etc. Any one of members belonging to the workspace belongs to the channel. The notification destination is identified by the workspace and the channel. However, because the method of identifying the notification destination differs depending on the chat system, as long as there is identification information that can uniquely identify the group, the identification information may be only one or specified by three or more pieces.

The channels are guaranteed to be unique. Member accounts 1-n are the accounts of the channel members, and this account is issued by the chat server 10. In this embodiment, a bot is registered as a member for informing about the reservation in the meeting room 6. The bot can be, so to speak, an agent of the meeting management server 30 or a fictitious member. The bot's speech (text) is transmitted to the terminal device 60 having member accounts 1-n.

The workspace and channels are managed by the meeting management server 30 to provide information to identify the group to which the participant belongs.

### <<Meetings Management Server>>

The meeting management server 30 includes a communication unit 31, an information supporting unit 32, a reservation information acquiring unit 33, a notification determining unit 34, a control information generating unit 35, a control information responding unit 36, a meeting information notifying unit 37, a check-in managing unit 38, a non-disclosure process unit 39, a non-disclosure information registration reception unit 40, and a reservation information transmitting unit 41. Each of these functional units of the meeting management server 30 is a function or means implemented in which each of the configuration categories illustrated in FIG. 4 is operated by a command from the CPU 201 according to the program 209p deployed from the HDD 209 to the memory 202. The program 209p is delivered from a program delivery server or distributed in a state where the program is stored in the memory medium.

The communication unit 31 transmits and receives various information with the reservation management server 20, the chat server 10, the registration terminal 50, and the terminal device 60. The communication unit 31 includes a transmission unit 31a and a reception unit 31b. The reception unit 31b receives reservation information from the reservation management server 20 and receives a request for reservation information from the meeting room terminal 90. The receiving unit 31b receives the check-in request from the meeting room terminal 90. The receiving unit 31b receives the mapping between the group of the chat system and the account from the registration terminal 50 operated by the administrator. The transmission unit 31a transmits the information concerning the reservation of the meeting room to the chat server 10 and transmits the reservation information to the meeting room terminal 90.

The information associating unit 32 mainly performs processing related to the pre-registration work. That is, the registration of the domain is received from the registration terminal 50 operated by the administrator, registered in the customer domain DB 495, and the workspace and the channel of the chat system transmitted from the registration terminal 50 and the account of the reservation management server 20 are associated so as to be registered in an associating information DB 491.

The reservation information acquiring unit 33 designates the account of the customer using the resource reservation system 100, acquires reservation information from the reservation management server 20, and registers the reservation information as the meeting management information in a meeting management information DB 493. An account of the registration or updated reservation information notified from the reservation management server 20 may be designated, or an arbitrary account may be designated. At least a portion of the reservation information of the reservation management server 20 is stored in the meeting management information DB 493. The reservation information acquiring unit 33 acquires future reservation information during a predetermined time period from now from among the reservation information held by the reservation management server 20. The predetermined time period is determined by how far ahead the reservation of the meeting room 6 is notified.

The notification determining unit 34 determines whether there is a reservation whose start date and time satisfying the condition of notification in the meeting management information. For example, referring to the notification setup DB 496, it is determined that the notification will be made when the date and time set is calculated backward from the start date and time of the reservation. Alternatively, when the reservation information acquiring unit 33 acquires the reservation information from the reservation management server 20, the notification determining unit 34 may generate a task in which the notification determining unit 34 notifies the reservation information and register the task in the queue. The task stored in the queue is executed when an execution time (the time to remind) reaches.

If bots are separated according to roles, for example, a bot for reminder and a bot for reservation reception, bots are specified according to the process.

The meeting information notifying unit 37 requests the chat server 10 to designate information identifying the bot (for example, a token in the case of slack) and information specifying the group of the notification designation, and to notify information regarding the reservation of the meeting room 6, when it is judged that the notification determining unit 34 notifies. The notifications are separately done several times. At least one of the notifications contains the meeting identification information. The meeting identification information is information for the meeting management server 30 to confirm that the participant has the right to use the reserved meeting room 6 during the reserved time period. The meeting information notifying unit 37 generates the meeting identification information at least before the final notification. The meeting identification information is registered in the meeting identification information DB 494.

The control information generating unit 35 generates control information of the electronic apparatus 70 by referring to the meeting management information and registers the control information in the control information DB 497. For example, several minutes prior to the start time of the meeting, control information is generated to turn on the power of the electronic apparatus 70, and control information is generated to turn off the power of the electronic apparatus 70 upon detection of a check-out. The control information is stored in the control information DB 497.

The control information responding unit 36 receives the inquiry as to whether the control information is present from the meeting room terminal 90 of the meeting room 6 and transmits the control information corresponding to the meeting room 6 to the meeting room terminal 90 with reference to the control information DB 497.

The check-in management 38 manages the check-in and check-out to the meeting room. Also, the status of the meeting due to the check-in/check-out is registered in the meeting management information DB 493. Check-in is acknowledged to be 5 to 10 minutes prior to the start date and time of the meeting specified by the reservation ID. When the set of the meeting room ID and the meeting identification information transmitted by the meeting room terminal 90 is registered in the meeting identification information DB 494, the check-in is permitted.

The non-disclosure process unit 39 performs the process of making the reservation information non-disclosure. First, there is a user-set priority mode in which the reservation information is not disclosed (the non-disclosure setup field in FIG. 8, the non-disclosure flag in Table 1) only when the reservation information is set to non-disclosure, and a forcible mode in which the reservation information is forcibly not disclosed (non-disclosure setup field in FIG. 8, non-disclosure flag in Table 1) even if the reservation information is not set to non-disclosure. These modes are previously set by the administrator. In the user-set priority mode, the non-disclosure process unit 39 judges whether the reservation information is set to non-disclosure (the non-disclosure setup field of FIG. 8 and the non-disclosure flag of Table 1 is ON).

In the case of reservation information that is set to non-disclosure, non-disclosure information DB498 is referred to determine whether the reservation information contains non-disclosure information. If the non-disclosure information is contained, an item that the corresponding non-disclosure target item is made non-display or fixed notation (non-disclosure setup) is created. In the case of the forcible mode, regardless of whether the non-disclosure is present or not (even the reservation information is not set to non-disclosure), if the reservation information contains non-disclosure information by referring to the non-disclosure information DB 498, the item that the corresponding non-disclosure target item is made non-display or fixed notation (non-disclosure setup) is created.

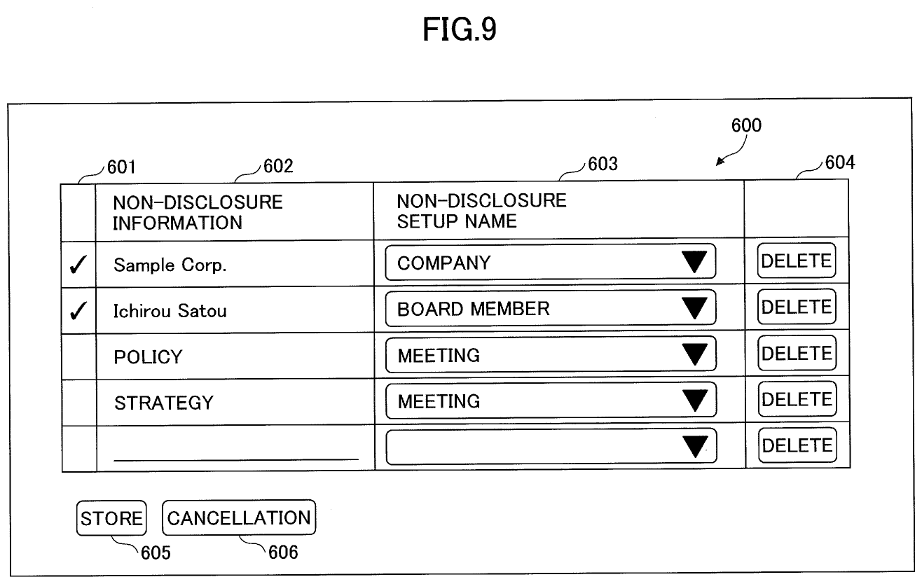

The non-disclosure information registration reception unit 40 provides a web application for receiving registration of non-disclosure information from the registration terminal 50. That is, the screen information of the non-disclosure information management screen (FIGS. 9 to 11) to be described later is generated and transmitted to the registration terminal 50 through the communication unit 31, and the registration terminal 50 receives the registration regarding the non-disclosure information. The non-disclosure information whose registration is accepted is stored in the non-disclosure information DB 498. The screen information is prepared by HTML, CSS (Cascade Style Sheet) and JavaScript (“JavaScript” is a registered trademark).

The reservation information transmission unit 41 transmits reservation information (meeting management information) stored in the meeting management information DB 493 in response to a request from the meeting room terminal 90. The reservation information transmitting unit 41 may be transmitted in a format of JSON, XML, CVS (Comma-Separated Values), or the like. Because the reservation information is transmitted repeatedly, it is advantageous to use a format with little capacity.

The meeting management server 30 includes a memory unit 49. The memory unit 49 is implemented by the memory 202 and the HDD 209 of FIG. 4. The memory unit 49 stores the associating information DB 491, the meeting management information DB 493, the meeting identification information DB 494, the customer domain DB 495, the notification setup DB 496, the control information DB 497, and the non-disclosure information DB 498.

TABLE 3
ASSOCIATING INFORMATION DB

| | | MEMBER | MEMBER | MEMBER | MEMBER |
|---|---|---|---|---|---|
| WORKSPACE | CHANNEL | ACCOUNT 1 | ACCOUNT 2 | ACCOUNT 3 | ACCOUNT 4 |
| http://sample.com/1 | #marketing | a@xfood.com | b@xfood.com | c@xfood.com | d@xfood.com |
| | | a@chat.com | b@chat.com | c@chat.com | d@chat.com |
| http://sample.com/2 | #team1 | f@xfood.com | g@xfood.com | h@xfood.com | |
| | | f@chat.com | g@chat.com | h@chat.com | |
| . . . | . . . | . . . | . . . | . . . | . . . |

Table 3 indicates an example of the associating information stored in the associating information DB 491. The associating information associates the account of the reservation management system with the group of chat system. The associating information contains the workspace, channel and member accounts 1 to n (n=4 in table). The workspaces and channels are as described above. The accounts of each participant issued by the reservation management server 20 are registered in the member accounts 1 to n. The account of the chat system may be registered as illustrated in Table 3. In order to notify the group, the reservation management server 20 may have information (in this embodiment, the workspace and the channel name) for specifying the account of the reservation management server 20 of the user who has reserved the meeting and the group and channel to which the meeting is to be notified. The account of all members belonging to the group need not necessarily be registered. However, when notifying to the individual user, the account information of each chat system is required, so it may be registered as illustrated in Table 3.

TABLE 4
MEETING MANAGEMENT INFORMATION

| | | NOTATION | AFFILIATION | | | START |
|---|---|---|---|---|---|---|
| | RESERVATION | NAME OF | NAME OF | | MEETING | DATE |
| RESERVATION | PERSON | RESERVATION | RESERVATION | MEETING | ROOM | AND |
| ID | ACCOUNT | PERSON | PERSON | NAME | ID | TIME |
| 001 | a@xfood.com | Tarou | SALES | MEETING | K-001 | 2017 |
| | | Tokkyo | DEPART- | ABOUT | | Jul. 7 |
| | | | MENT | AUTO- | | 10:00 |
| | | | | MATED | | |
| | | | | DRIVING | | |
| | | | | WITH | | |
| | | | | Sample | | |
| | | | | Corp. | | |
| 002 | e@xfood.com | Ichirou | BOARD | DEVEL- | K-001 | 2017 |
| | | Satou | MEMBER | OPMENT | | Jul. 7 |
| | | | | OF COM- | | 13:00 |
| | | | | MERCIAL | | |
| | | | | PRODUCT | | |
| | | | | Y | | |
| . . . | . . . | . . . | . . . | . . . | . . . | . . . |

| | END | | | | |
|---|---|---|---|---|---|
| | DATE | PROSPECTIVE | NOTATION | AFFILIATION | |
| RESERVATION | AND | PARTICIPANT | NAME OF | NAME OF | |
| ID | TIME | ACCOUNT | PARTICIPANT | PARTICIPANT | STATUS |
| 001 | 2017 | b@xfood.com | Tarou | DEVELOPMENT | ALREADY |
| | Jul. 7 | | Jitsuyou | DEPARTMENT | CHECKED |
| | 12:00 | c@xfood.com | Tarou | PERSONNEL | IN |
| | | | Ishou | DEPARTMENT | |
| | | d@xfood.com | Tarou | ACCOUNTING | |
| | | | Shouhyou | DEPARTMENT | |
| 002 | 2017 | f@xfood.com | Tarou | PURCHASE | ALREADY |
| | Jul. 7 | | Chosaku | DEPARTMENT | NOTI- |
| | 14:00 | g@xfood.com | Tarou | PUBLIC | FIED |
| | | | Fukyou | RELATIONS | |
| | | | | DEPARTMENT | |
| . . . | . . . | . . . | . . . | . . . | . . . |

Table 4 indicates an example of the meeting management information stored in the meeting management information DB 493 of the meeting management server 30. Because the reservation information is stored in the meeting management information DB 493, the difference from the reservation information DB 291 in Table 1 is explained for Table 4. The meeting management information in Table 4 contains items of a notation name of the reservation person, an affiliation name of the reservation person, a notation name of the participant, an affiliation name of the participant, and a status. The notation name of the reservation person is a name of the reservation person or the like. The affiliation name of reservation person is the department name to which the reservation person belongs. The notation name of the participant is the name of the participant. The affiliation name of the participant is the name of the department to which the participant belongs. Because the meeting management server 30 can retain or use the user information associated with the account, the notation name, the affiliation name, or the like, the notation name, the affiliation name, or the like are known when the account is known. Further, the reservation management server 20 may include the notation name of the reservation person, the affiliation name of the reservation person, the notation name of participant, and the affiliation name of the participant at the time of transmission.

The status means the status of the reservation. For example, the status of whether information about the reservation in the meeting room 6 has been already notified, whether the use of the meeting room has been confirmed, whether the room has been checked in, whether the room has been checked out, or whether the room has been cancelled information about the reservation in the meeting room 6 is registered.

TABLE 5
MEETING IDENTIFICATION INFORMATION DB

| | | MEETING |
|---|---|---|
| RESERVATION | MEETING | IDENTIFICATION |
| ID | ROOM ID | INFORMATION |
| 001 | K-001 | 1234 |
| 002 | K-002 | 5678 |
| . . . | . . . | . . . |

Table 5 indicates an example of the management information of the meeting identification information stored in the meeting identification information DB 494. The Meeting Identification Information Management Information is information that manages the Meeting Identification Information for each reservation in the Meeting Room 6. The meeting identification information management information contains the reserved ID, the meeting room ID, and each item of the meeting identification information. These are the same as the reservation information except for the status (the reservation information received from the reservation management server 20) and the description thereof will not be repeated. Note that the reservation ID is registered in order to identify the reservation in the same meeting room 6.

TABLE 6
CUSTOMER DOMAIN DB

| CUSTOMER | ADMINISTRATOR |
|---|---|
| DOMAIN NAME | ACCOUNT OF CUSTOMER |
| xfood.com | a@xfood.com |
| ycar.com | f@ycar.com |
| . . . | . . . |

Table 6 indicates an example of the customer domain information stored in the customer domain DB 495. Customer domain information is information that manages the customer's domain and the account of the customer's administrator. Customer domain information is registered with a customer domain name and a customer administrator account. The customer domain of Table 6 is the account (e-mail address) domain issued by the reservation management server 20. The administrator account is the account of the customer's administrator (representing). The account in Table 6 is issued by the reservation management server 20.

TABLE 7
NOTIFICATION SETUP DB

| CUSTOMER DOMAIN NAME | NOTIFICATION SETUP |
|---|---|
| xfood.com | BEFORE 1 DAY |
| ycar.com | BEFORE 12 HOURS |
| . . . | . . . |

Table 7 indicates an example of notification setup information stored in the notification setup DB 496. The notification setup information retains related to notification setup for each customer. The customer domain name and notification setup are registered in the notification setup information. The notification setup has a timing indicating that how early before the start date and time of the meeting the information related to the reservation of the meeting room 6 is notified. Alternatively, a predetermined date and time may be set. Also, it is not necessary to have only one timing, and multiple notification setups may be registered for one customer.

TABLE 8
CONTROL INFORMATION DB

| MEETING ROOM ID | CONTROL CONTENT |
|---|---|
| K-001 | POWER ON |
| K-002 | POWER OFF |
| . . . | . . . |

Table 8 illustrates an example of control information stored in control information DB 497. The control information is information for controlling the electronic apparatus 70 of the meeting room 6. The control information contains items of the meeting room ID and the control content. The control content is a specific control method of the electronic apparatus 70. The meeting management server 30 can set detailed control content for each electronic apparatus 70. Further, the time to be controlled is not registered because it is difficult to transmit the time from the meeting management server 30 of the external network to the meeting room terminal 90, and the meeting room terminal 90 accesses the meeting management server 30, and at this time, if the control information is generated, the control content is transmitted.

TABLE 9A
MEETING ROOM K-001

| NON- | NON- | NON- | NON- | TO BE |
|---|---|---|---|---|
| DISCLOSURE | DISCLOSURE | DISCLOSURE | DISCLOSURE | EXECUTED/ |
| INFORMATION | SETUP NAME | TARGET ITEM | METHOD | NOT |
| POLICY | MEETING | MEETING NAME | FIXED NOTATION 1 | TRUE |
| DETERMINATION | ARRANGEMENT | AFFILIATION OF | NON-DISPLAY | TRUE |
| | | PARTICIPANT | | |
| NEGOTIATION | EXTERNAL | PARTICIPANT NAME | FIXED NOTATION 6 | TRUE |
| | MEETING | | | |
| Sample Corp. | COMPANY | MEETING NAME | NON-DISPLAY | TRUE |
| Ichirou Satou | BOARD | RESERVATION PERSON | FIXED NOTATION 5 | FALSE |
| | MEMBER | | | |
| OO | GROUP | MEETING NAME | FIXED NOTATION 3 | TRUE |
| STRATEGY | | | | |
| ROOM | | RESERVATION PERSON | NON-DISPLAY | |
| OO | GROUP | MEETING NAME | FIXED NOTATION 3 | TRUE |
| LICENSE | | | | |
| GROUP | | RESERVATION PERSON | NON-DISPLAY | |
| PRESIDENT | BOARD | RESERVATION PERSON | FIXED NOTATION 5 | TRUE |
| | MEMBER | | | |
| GENERAL | DEPARTMENT | AFFILIATION NAME OF | FIXED NOTATION 4 | FALSE |
| MANAGER | MANAGER | RESERVATION PERSON | | |
| DEPARTMENT | DEPARTMENT | AFFILIATION NAME OF | FIXED NOTATION 4 | FALSE |
| MANAGER | MANAGER | RESERVATION PERSON | | |
| EXECUTIVE | BOARD | RESERVATION PERSON | FIXED NOTATION 5 | FALSE |
| OFFICER | MEMBER | | | |

TABLE 9B

| FIXED NOTATION ID | FIXED NOTATION |
|---|---|
| FIXED NOTATION 1 | MEETING |
| FIXED NOTATION 2 | ARRANGEMENT |
| FIXED NOTATION 3 | REGULAR CONFERENCE |
| FIXED NOTATION 4 | BLANK |
| FIXED NOTATION 5 | HYPHEN (-) |
| FIXED NOTATION 6 | ASTERISK (*) |

TABLE 9C

| | |
|---|---|
| OPERATION MODE | USER-SET PRIORITY MODE/FORCIBLE |

Table 9A indicates an example of the setup for the non-disclosure information stored in the non-disclosure information DB 498, and Table 9B indicates an example of the fixed notation information. First, the non-disclosure information DB 498 has items such as non-disclosure information, a non-disclosure setup name, a non-disclosure target item, a non-disclosure method, and whether the non-disclosure is to be executed/not. The non-disclosure information is information that is an object of the non-disclosure if it is contained in the reservation information. They can be called a non-disclosure string or non-disclosure word. The non-disclosure setup name is the name of the non-disclosure setup regarding how to make the reservation information that is found to contain the non-disclosure information non-disclosure. When the administrator selects the non-disclosure setup name for ease of operation, the non-disclosure target item and the non-disclosure method are determined. The non-disclosure target item indicates which items of reservation information is made non-disclosure. Thus, information related to the display may contain the item to be made non-disclosure. The non-disclosure method indicates whether the non-disclosure information is subjected to fixed notation or non-display. To be executed/not indicates whether the meeting management server 30 performs the process to make the corresponding non-disclosure information non-disclosure. As described below, each of these setups can be performed by the administrator.

The non-disclosure information DB 498 corresponds to the meeting room ID and can be configured for each meeting room. With this, for example, the non-disclosure information specific to the meeting for the board members can be set in the reservation information for the meeting for the board members. However, the non-disclosure information DB 498 may be common to all meeting rooms or multiple meeting rooms.

The fixed notation information is information that replaces items that are not disclosed when the method of non-disclosure is fixed notation. The fixed notation ID is associated with a specific fixed notation, and the meeting room terminal 90 can identify the fixed notation using the fixed notation ID. The fixed notation information may be downloaded from the meeting management server 30, such as at the time of initial setup, or transmitted to the meeting room terminal 90 along with the reservation information.

Table 9C indicates operation mode setup information in which the user-set priority mode or the forcible mode is set. The administrator can previously set the user-set priority mode or the forcible mode. If the administrator does not set, the default operation mode is the forcible mode. This improves security. It is preferable that the operation mode setup information be set for each meeting room. The operation mode can be used differently such that the forcible mode is used in the meeting room where an important meeting is held and the user-set priority mode is used in a meeting room where only an in-house general meeting is held.

Even if the administrator forgets to set the non-disclosure setup on the registration terminal 50, the leakage of confidential information can be suppressed by changing the display content. The content of the reservation can be changed to a uniform expression by the meeting management server 30. In addition, the display can be set individually by the meeting room terminal 90 which is provided for each meeting room (resource).

### <<Registration Terminal>>

The registration terminal 50 includes a communication unit 51, an operation reception unit 52, and a display control unit 53. Each of these functional units of the registration terminal 50 is a function or means implemented in which one of the components illustrated in FIG. 4 is operated by an instruction from the CPU 201 according to the program 209p deployed from the HDD 209 to the memory 202. The program 209p is delivered from a program delivery server or distributed as stored on a memory medium.

The registration terminal 50 is a terminal for performing various setups related to the meeting room by the administrator through the web page provided by the meeting management server 30. One of these setups is the setup of non-disclosure information indicated in Table 9A. The terminal device 60 may be used for setup the non-disclosure information. The functions of the communication unit 51, the operation reception unit 52, and the display control unit 53 of the registration terminal 50 is the same as that of the terminal device 60. Therefore, these functions will be described in detail with the function of the terminal device 60.

### <<Terminal Device>>

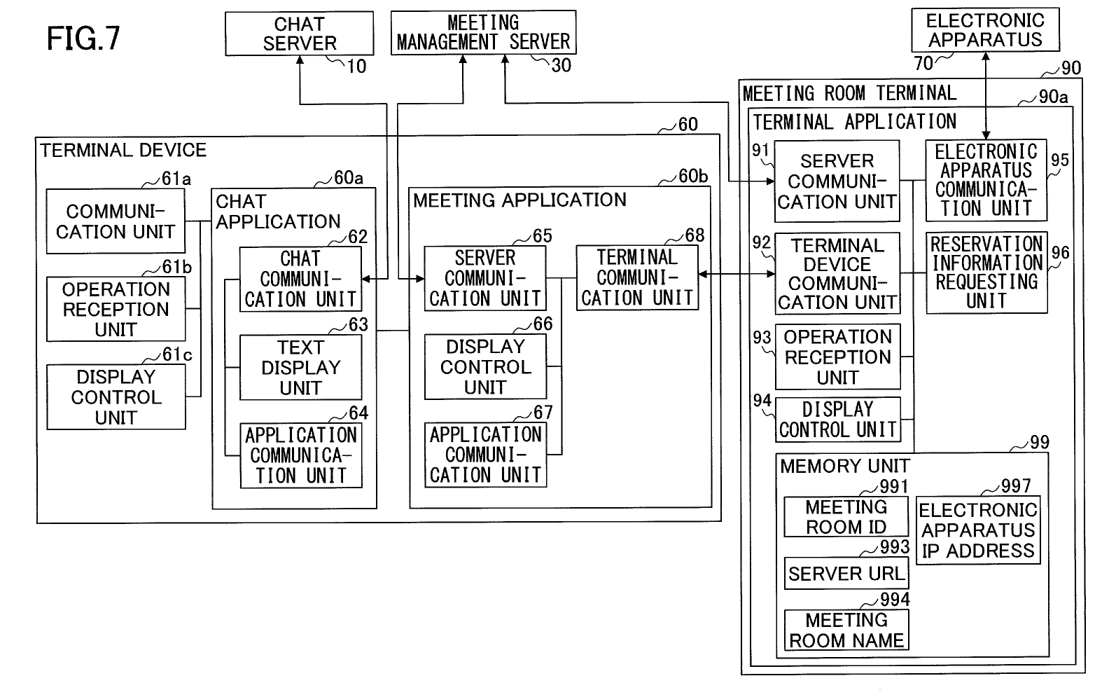

FIG. 7 is an example of the functions of the terminal device 60 and the meeting room terminal 90 illustrated in a block shape. The functions of the electronic apparatus 70 will be described as needed.

The terminal device 60 includes a communication unit 61a, an operation reception unit 61b, a display control unit 61c, a chat communication unit 62, a text display unit 63, an application communication unit 64, a server communication unit 65, a display control unit 66, an application communication unit 67, and a terminal communication unit 68. Each of the functional units provided by the terminal device 60 is a function or a means that is implemented by any part of the configuration illustrated in FIG. 4 being operated by a command from the CPU 201 according to the program 209p expanded from the HDD 209 to the memory 202. The program 209p is delivered from a program delivery server or distributed as stored on a memory medium. Because the chat application 60a and the meeting application 60b are operated in the terminal device 60, the program 209p contains the chat application 60a and the meeting application 60b.

The communication unit 61a transmits and receives various information from the meeting management server 30 and the reservation management server 20. The chat application 60a communicates with the chat server 10 and the meeting application 60b communicates with the meeting management server 30, whereas the communication unit 61 communicates with any server. The communication unit 61a may be provided, for example, as a browser function.

The operation reception unit 61b receives various operations of the participant in the terminal device 60. The display control unit 61c interprets screen information of various screens and displays the interpreted on the LCD 206. The operation reception unit 61b and the display control unit 61c have, for example, browser functions and can execute a web application. For example, the display control unit 61c displays the reservation setup screen received from the reservation management server 20, and the operation reception unit 61b receives reservation information set by the reservation person.

The chat communication unit 62 of the chat application 60a transmits and receives various information from the chat server 10. According to this embodiment, the information regarding the reservation of the meeting room 6 is received from the chat server 10, and the chat server 10 is notified of an issue that the information related to the reservation of the meeting room 6 has already been received and read, an issue whether the meeting room 6 is to be used or cancelled, or the like.

The text display unit 63 of the chat application 60a displays the text (information concerning the reservation of the meeting room 6) transmitted from the chat server 10. For example, the source of the message is a bot and the text is displayed as if the bot has input it.

The application communication unit 64 of the chat application 60a calls the meeting application 60b and transmits the meeting identification information to the meeting application 60b. The chat server 10 transmits information identifying the meeting application 60b to the terminal device 60 when the information regarding the reservation of the meeting room 6 is notified. Therefore, the chat application 60a designates the meeting application 60b to the OS and requests the OS to notify the meeting identification information. The OS can start up the meeting application 60b.

The server communication unit 65 of the meeting application 60b communicates with the meeting management server 30. The two-dimensional code containing the meeting identification information is acquired from the meeting management server 30 or the like. The two-dimensional code is used for authentication when checked in. It may be a several number of digits for authentication.

The display control unit 66 of the meeting application 60b displays the two-dimensional code containing the meeting identification information on the LCD 206. The application communication unit 67 of the meeting application 60b acquires various information (such as meeting identification information contained in the information concerning the reservation of the meeting room 6) from the chat application 60a through the OS.

The terminal communication unit 68 communicates with the meeting room terminal 90 and transmits the meeting identification information or the like. The terminal communication unit 68 detects the presence of the meeting room terminal 90 by near range radio communication such as Bluetooth (“Bluetooth” is a registered trademark) and transmits meeting identification information when the meeting room terminal 90 is detected. Further, a function for displaying (capturing the image of) the two-dimensional code is provided to the meeting room terminal 90.

### <<Meeting Room Terminal>>

The meeting room terminal 90 includes a server communication unit 91, a terminal device communication unit 92, an operation reception unit 93, a display control unit 94, an electronic apparatus communication unit 95, and a reservation information requesting unit 96. Each of these functional units provided by the meeting room terminal 90 is a function or means that is implemented in which each of the configurations illustrated in FIGS. 5A and 5B is operated by a command from the CPU 301 according to the program 604p deployed from the EEPROM 304 to the RAM 303. The program 604p is delivered from a program delivery server or distributed as stored on a memory medium.

The server communication unit 91 communicates with the meeting management server 30 by using the server URL 993 as the destination. Because the meeting room terminal 90 is present in the internal network, it is difficult to communicate with the meeting room terminal 90 from the meeting management server 30. For this reason, the server communication unit 91 communicates with the meeting management server 30 by communication technology such as polling (regularly communicating with the meeting management server 30) or WebSocket. The server communication unit 91 may communicate with a communication protocol such as HTTP, and the communication protocol is not particularly limited.

The server communication unit 91 according to this embodiment receives the reservation information and transmits the meeting identification information received by the terminal device communication unit 92 from the terminal device 60 or the manually input meeting identification information to the meeting management server 30 at the check-in time. The server communication unit 91 receives the control information from the meeting management server 30.

The terminal device communication unit 92 communicates with the terminal device 60. In this embodiment, the meeting identification information or the like is received. When the meeting identification information is input by hand, the terminal device communication unit 92 may not be necessary. The terminal device communication unit 92 is implemented by controlling a short-range wireless communication unit 315 or an RF tag reader/writer 322 by executing the program 604p of the CPU 301 of FIGS. 5A and 5B.

The electronic apparatus communication unit 95 communicates with the electronic apparatus 70. In this embodiment, the control information received by the server communication unit 91 is transmitted to the electronic apparatus 70. The electronic apparatus communication unit 95 is implemented by the CPU 301 of FIGS. 5A and 5B executing the program 604p and controlling the wireless LAN communication unit 313.

The display control unit 94 displays a screen generated by the terminal application 90a on the display 316. The screen is a standby screen 501 which can be checked in and out. The display control unit 94 of this embodiment judges whether the reservation information (in particular, the meeting management information of Table 4) is set to non-disclosure. When it is set to non-disclosure, the display control unit 94 makes the non-disclosure target item associated with the non-disclosure setup non-display or fixed notation. In the fixed notation instructed, the fixed notation information of Table 9b is transmitted from the meeting management server 30, or the same is stored in the memory unit 99 of the meeting room terminal 90.

The operation reception unit 93 receives various operations for the meeting room terminal 90. For example, check-in, reception of a manual input of meeting identification information, or check-out are received.

At the periodic timing of acquiring the reservation information, the reservation information requesting unit 96 repeatedly transmits the meeting room ID 991 stored in the memory unit 99 through the server communication unit 91 to the meeting management server 30. As a response, the reservation information requesting unit 96 acquires the reservation information through the server communication unit 91. The reservation information can be acquired only when there is a change. The timing is a cycle of several seconds to several minutes. The shorter the cycle, the earlier the reservation information can be updated. However, because the communication load becomes higher, the determination is made by considering both the earlier and the communication load. In this embodiment, for example, 30 seconds. At least the meeting management information (reservation information) of the meeting room 6 of the present day can be received through the server communication unit 91.

The meeting room terminal 90 includes the memory unit 99. The memory unit 99 is implemented by the ROM 302, the EEPROM 304, or the like of FIGS. 5A and 5B. The meeting room ID 991 for specifying the meeting room, the server URL 993 of the meeting management server 30, the meeting room name 994, and the IP address 997 of the electronic apparatus 70 are displayed on the standby screen 501 are stored in the memory unit 99.

### <Example of Reservation Setup Screen Displayed by Terminal Terminal>

FIG. 8 illustrates an example of the reservation setup screen 400 displayed by the terminal device 60. FIG. 8 is a simplified screen example, and the items not described in this embodiment are omitted.

The reservation setup screen 400 includes a meeting name entry field 401, a start date input field 402a, a start time input field 402b, an end date input field 403a, an end time input field 403b, a meeting room selection field 404, a non-disclosure setup field 405, and a participant name field 406. The reservation person logs in to the reservation management server 20 at the account of the reservation management server 20 and enters the necessary information into the reservation setup screen 400.

Meetings name entry field 401 is the field to be input by the reservation person for any meetings name. Generally, the name of the meeting to which the content of the meeting can be grasped is input. In the start date input field 402a and end date input field 403a, for example, a date selected from the calendar displayed by the reservation person is input. In the start time input field 402b and the end time input field 403b, for example, a list of 15-minute time intervals is displayed in pull-down form and the reservation person's selected time is input.

In the meeting room selection field 404, a list of meeting rooms 6 is displayed in a pull-down format, allowing the reservation person to select a meeting room arbitrarily. Incidentally, the meeting room displayed is a meeting room that is vacant at the time specified in a start date input field 402a, a start time input field 402b, an end date input field 403a, and an end time input field 403b.

A non-disclosure setup field 405 sets whether the information in this meeting should be made non-disclosure by the reservation person (corresponding to the non-disclosure flag in Table 1). The non-disclosure flag is referenced by the meeting management server 30 when the operation mode is a user-set priority mode and not when the operation mode is a forcible mode. In the user-set priority mode, if the non-disclosure setup field 405 is checked, it is set to non-disclosure (non-disclosure flag ON) and if not checked, it is not set to non-disclosure (non-disclosure flag OFF). Participant name field 406 is the field in which the registrant enters any participant name. For example, a previously set participant's name can be input without re-entry using the browser's cookie function.

### <Configuring Non-Disclosure Information>

Next, a method of setup the non-disclosure information will be described with reference to FIGS. 9 to 11. FIG. 9 indicates an example of a non-disclosure information management screen 600. The non-disclosure information management screen 600 includes a check box field 601, a non-disclosure information field 602, a non-disclosure setup name field 603, and a deletion button 604.

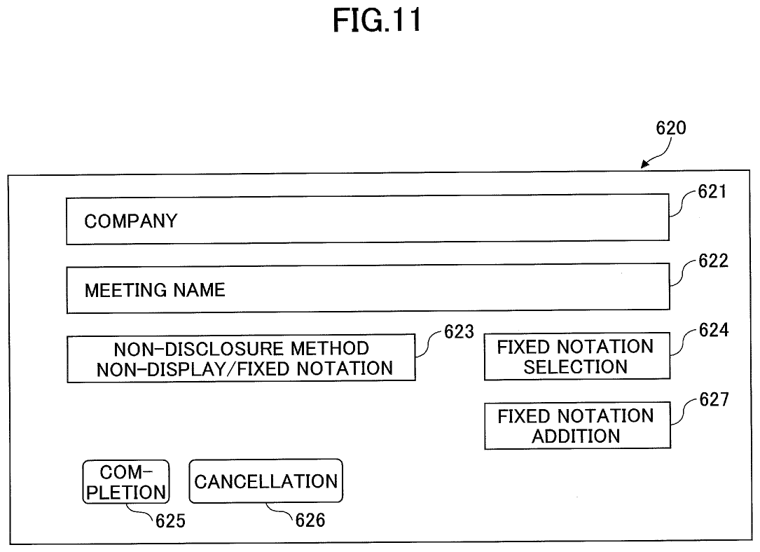

The non-disclosure information field 602 indicates information for searching all information contained within the reservation information. If the reservation information contains the same information as the non-disclosure information in the non-disclosure information field 602, the non-disclosure target item of this reservation information (see FIG. 11) will be made non-disclosure (non-display or fixed notation). When the operation mode is the forcible mode, the reservation information containing the same information as the non-disclosure information is made non-disclosure even when the non-disclosure setup field 405 is not checked on the reservation setup screen 400 of FIG. 8. With this, if the reservation person has forgotten to check the non-disclosure setup, the non-disclosure information can be made non-disclosure.

The non-disclosure setup name field 603 is the name of the non-disclosure setup. The administrator can easily set the items to non-disclosure and the method to non-disclosure by selecting the name of the non-disclosure setup. That is, the non-disclosure setup name can be used to determine the items to be disclosed and the non-disclosure method (see Table 9A). Delete button 604 is a button for the administrator to delete one record (a set of check boxes, non-disclosure information, and non-disclosure setup names).

The check box field 601 is a field for setting whether the corresponding non-disclosure information is searched using the reservation information. That is, it can be set to effective or not non-disclosure setups for a single record. The setup in the check box field 601 corresponds to “to be executed/not” in Table 9A.

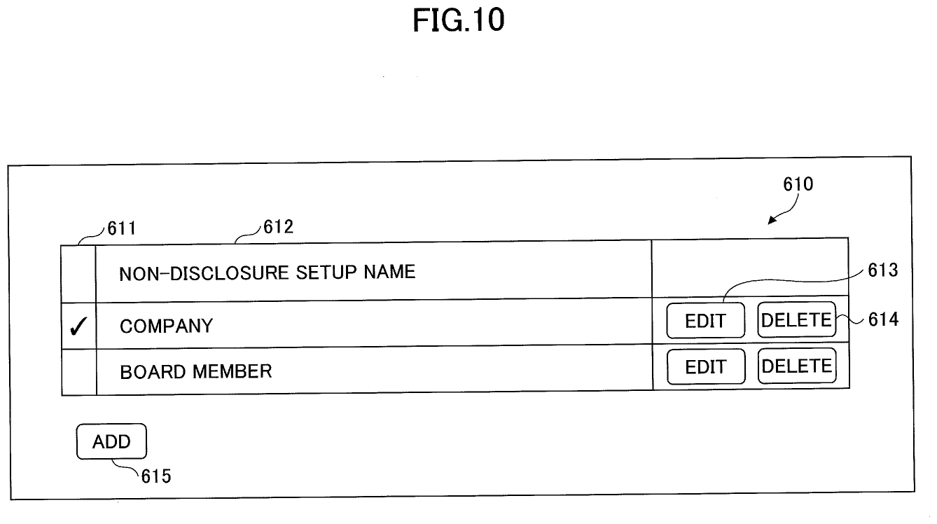

The bottom record of the non-disclosure information management screen 600 is blank. Therefore, the administrator can input new non-disclosure information. When the non-disclosure setup name field 603 is pressed, the previously created non-disclosure setup name is pulled down. The detailed setup of each non-disclosure setup will be described in FIGS. 10 and 11. When new non-disclosure information is input, a new blank record is added at the bottom of the non-disclosure information management screen 600.

The non-disclosure information management screen 600 includes a store button 605 and a cancel button 606. The store button 605 stores the edit state from the time when the registration terminal 50 opens to the time when the store button 605 is pressed on the non-disclosure information management screen 600. The cancel button 606 discards the edit state from when the non-disclosure information management screen 600 is opened until when the cancel button 606 is pressed.

FIG. 10 illustrates an example of the non-disclosure setup management screen 610 displayed by the registration terminal 50. The non-disclosure setup management screen 610 is a screen on which the administrator edits or adds the non-disclosure setup. The non-disclosure setup management screen 610 includes a check box field 611, a non-disclosure setup name field 612, an edit button 613, and a delete button 614.

The check box field 611 is the field in which the administrator sets whether to use the non-disclosure setup in the non-disclosure setup name field 612. When the check box field 611 is checked, the non-disclosure setup becomes available, and when not checked, the non-disclosure setup becomes unavailable.

The edit button 613 is a button for editing the content of the non-disclosure setup designated in non-disclosure setup name field 612. When the edit button 613 is pressed, a non-disclosure setup edit screen 620 of FIG. 11 is displayed. Delete button 614 is a button for deleting from the non-disclosure setup management screen 610 the non-disclosure setup designated in the non-disclosure setup name field 612.

In addition, the non-disclosure setup management screen 610 includes an add button 615. The add button 615 is a button for displaying a new non-disclosure setup added to the non-disclosure setup management screen 610. When the add button 615 is pressed, the non-disclosure setup edit screen 620 of FIG. 11 is displayed.

FIG. 11 illustrates an example of the non-disclosure setup edit screen 620. The non-disclosure setup edit screen 620 includes a non-disclosure setup name field 621, a non-disclosure target item field 622, a non-disclosure method field 623, a fixed notation selection button 624, a fixed notation addition button 627, a completion button 625, and a cancellation button 626.

The non-disclosure setup name field 621 is a field for the administrator to edit the name for storing the non-disclosure setup. If the administrator edits the existing non-disclosure setup, the non-disclosure setup name which is not yet edited is pre-displayed. The non-disclosure target item field 622 is a field that is displayed in a pull-down menu or the like in the reservation information so as to be made non-disclosure and is selected by the administrator. All items contained in the reservation information and the information associated with the account may become non-disclosure target items, such as meeting name, a participant name, a reservation person name, an affiliation name of participant, an affiliation name of reservation person, etc. can be selected. It is preferable that items that should not be non-disclosure, such as a meeting start date and time and a meeting end date and time, is preferably prevented from being selected.

The administrator can arbitrarily select the non-disclosure target item in the non-disclosure target item field 622. Therefore, the item that do not contain the non-disclosure information as well as the item that contains the non-disclosure information can be set to non-disclosure. In general, the item containing the non-disclosure information should be kept non-disclosure. Therefore, an item containing the non-disclosure information may be set in the non-disclosure target item field 622.

In addition, the number of the non-disclosure target items is not limited to one. Two or more non-disclosure target items may be set. In this case, the non-disclosure setup edit screen 620 may have a plurality of non-disclosure target item fields 622.

The non-disclosure method field 623 displays, for example, a pull-down menu indicating whether the non-disclosure target items are to be made non-display or fixed notation when the non-disclosure target item is made non-disclosure and accepts the selection by the administrator. Also, when the administrator selects the fixed notation in the non-disclosure method field 623, a fixed notation selection button 624 is displayed. When the fixed notation selection button 624 is pressed, the fixed notation already registered is displayed, for example, in a pull-down menu, allowing selection by the administrator. The fixed notation addition button 627 is a button for the administrator to add the fixed notation. The new fixed notation addition button 627 can be added by the administrator by pressing the fixed notation addition button 627. Thus, the fixed notation can be added to the fixed notation information in Table 9B.

The completion button 625 is a button for storing the edit state of between the time when the non-disclosure setup edit screen 620 is opened by the registration terminal 50 and the time when the completion button 625 is pressed. The cancellation button 626 is a button for discarding the edit state from the time when the non-disclosure setup edit screen 620 is opened to the time when the cancellation button 626 is pressed.

### <Operation Procedure>

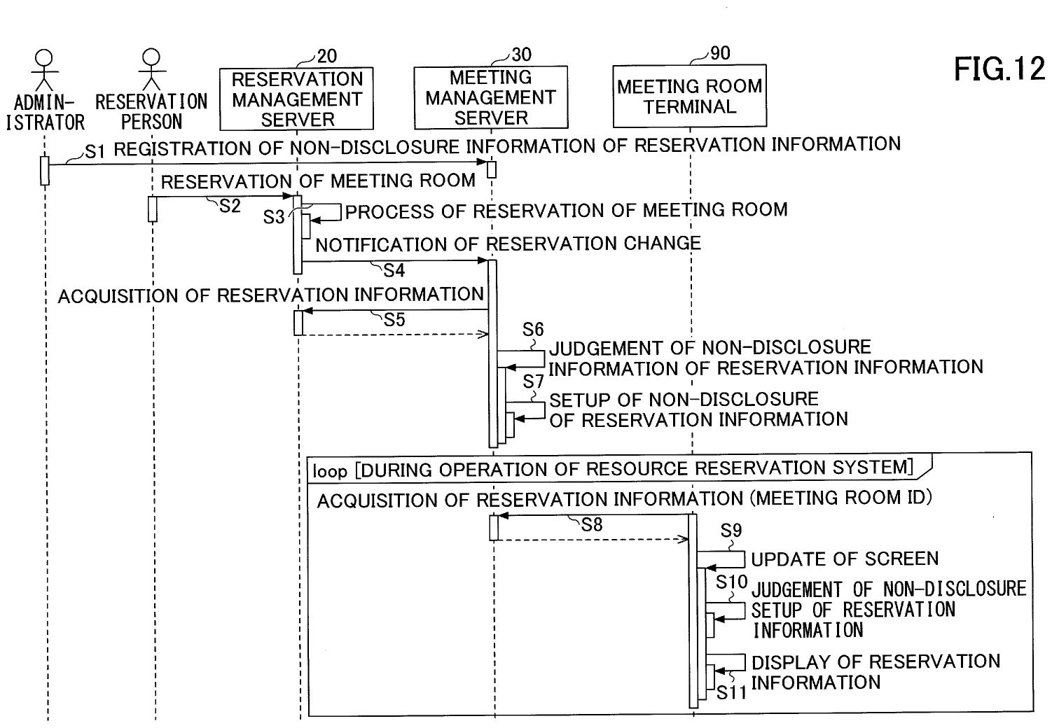

FIG. 12 is a sequence diagram illustrating an example of a procedure in which the meeting room terminal 90 makes the reservation information displayed on the standby screen 501 non-disclosure.

S1: The administrator operates the registration terminal 50 to communicate the registration terminal 50 with the meeting management server 30. The non-disclosure information registration reception unit 40 of the meeting management server 30 transmits screen information of the screen illustrated in FIGS. 9 to 11 to the registration terminal 50 as a web application. The communication unit 51 of the registration terminal 50 receives screen information, and the display control unit 53 of the registration terminal 50 displays the screen illustrated in FIGS. 9 to 11. When the administrator sets the non-disclosure information or the like, the operation reception unit 52 receives the non-disclosure information, the non-disclosure setup name, the non-disclosure target item, the non-disclosure method, and to be executed/not, and the communication unit 51 transmits them to the meeting management server 30. The non-disclosure information registration reception unit 40 of the meeting management server 30 registers these in the non-disclosure information DB 498.

S2: The reservation person reserves the meeting room to the reservation management server 20 at an arbitrary time. That is, the reservation setup screen shown in FIG. 8 is displayed on the terminal device 60 (an example of the reservation terminal), and the reservation person enters the name of the meeting, the start time of the meeting, the end time of the meeting, the end time of the meeting, the participant, the meeting room, and the non-disclosure setting. The operation reception unit 61b of the terminal device 60 receives the reservation information. The communication unit 61a transmits reservation information to the reservation management server 20.

S3: The communication unit 21 of the reservation management server 20 receives the reservation information, and the reservation information management unit 22 registers the reservation information in the reservation information DB 291.

S4: The communication unit 21 of the reservation management server 20 notifies the meeting management server 30 that the reservation information has been updated by designating the account of the reservation person.

S5: The communication unit 31 of the meeting management server 30 receives the issue that the reservation information has been updated, and the reservation information acquiring unit 33 designates the account to the reservation management server 20, requests the reservation information, and acquires the reservation information. The reservation information may be designated by information specifying the reservation, such as the reservation ID, the meeting room name, and the reservation start date and time.

S6: The non-disclosure process unit 39 of the meeting management server 30 judges whether the non-disclosure information registered in the non-disclosure information DB 498 is contained in the reservation information. When the operation mode is forcible, it is not necessary to judge whether the non-disclosure setup is checked (non-disclosure flag) at the time of judgment. When the operation mode is the user-set priority mode, it is judged whether the non-disclosure information is contained in the reservation information only when the non-disclosure setup is checked (non-disclosure flag: ON).

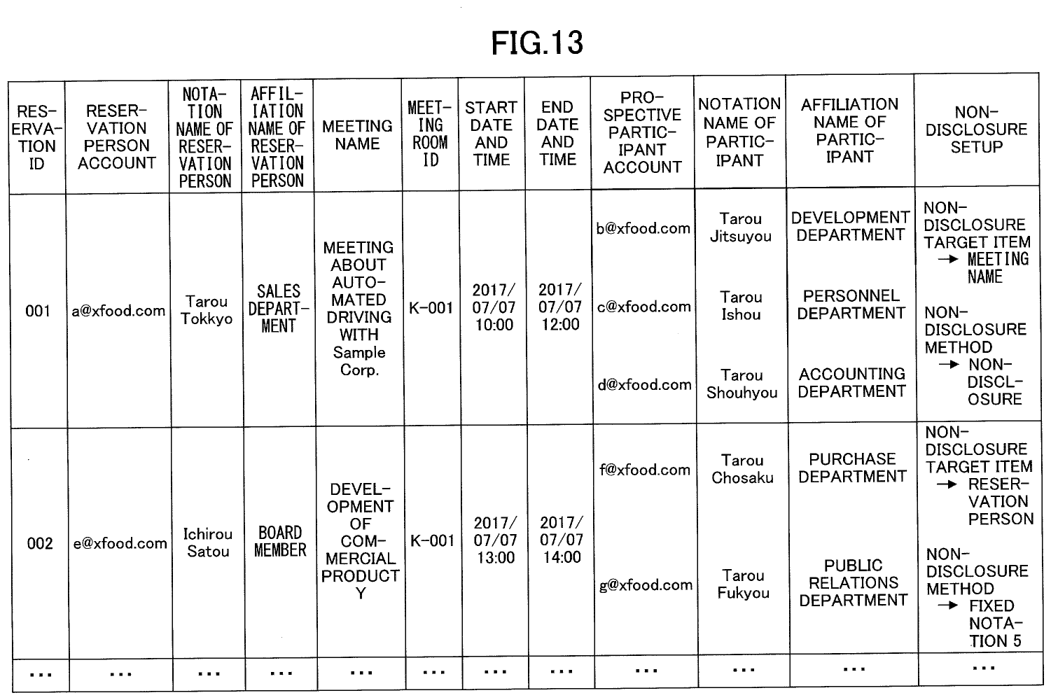

S7: The non-disclosure process unit 39 of the meeting management server 30 performs the process for making the non-disclosure target item of the reservation information containing the non-disclosure information non-disclosure. Said differently, the non-disclosure method is created for each non-disclosure target item, and the non-disclosure setup is mapped to the meeting management information. FIG. 13 indicates the meeting management information, containing a non-disclosure setup.

S8: The reservation information requesting unit 96 of the meeting room terminal 90 specifies the meeting room ID to the meeting management server 30 at regular intervals to request reservation information of the meeting room. Accordingly, when a predetermined time elapses from the registration of the reservation information, the meeting management server 30 acquires the reservation information.

S9: When the display control unit 94 of the meeting room terminal 90 acquires the reservation information from the meeting management server 30, the display control unit 94 starts the updating process of the standby screen 501.

S10: The display control unit 94 of the meeting room terminal 90 determines whether the non-disclosure setup is contained for each reservation information obtained from the meeting management server 30.

S11: The display control unit 94 of the meeting room terminal 90 reflects the non-disclosure setup in the reservation information to display the standby screen 501. Said differently, the non-disclosure target item designated as the non-disclosure setup is set to the non-display or fixed notation depending on the designated non-disclosure method.

<Reservation Information Transmitted from the Meeting Management Server to the Meeting Room Terminal>

FIG. 13 illustrates an example of the meeting management information that is transmitted by the meeting management server 30 to the meeting room terminal 90. In FIG. 13, the non-disclosure setup item is added to the meeting management information in Table 4. The reservation ID=001 has the name of the meeting name, namely, “Meeting about automated driving with Sample Corp” and includes the non-disclosure information “Sample Corp.” in Table 9A. Table 9A indicates that the non-disclosure target item is the meeting name and the non-disclosure method is set to non-display, FIG. 13 sets the non-disclosure setup as follows. “non-disclosure target item to meeting name non-disclosure method to non-display”

Reservation information of the reservation ID=002 indicates the reservation person is “e@xfoof.com”, but the notation name of the account “e@xfoof.com” is “Ichirou Satou”. “Ichirou Satou” is registered in the non-disclosure information in Table 9A. According to Table 9A, the non-disclosure target item is the reservation person and the non-disclosure method is the fixed notation 5. Therefore, in FIG. 13, the non-disclosure setup is set as follows: “Non-disclosure target item to Reservation person Non-disclosure method to Fixed notation 5”.

The display control unit 94 of the meeting room terminal 90 displays the non-disclosure target item displayed on the standby screen 501 in the non-display or fixed notation based on the reservation information as illustrated in FIG. 13. When the non-disclosure method is non-display, the non-disclosure process unit 39 of the meeting management server 30 may delete the non-disclosure target item of the reservation information. Similarly, when the non-disclosure method is a fixed notation, the non-disclosure process unit 39 of the meeting management server 30 may replace the non-disclosure target items of the reservation information with the fixed notation in Table 9B. In this way, the meeting room terminal 90 can display the reservation information as in the past.

However, because the reservation information transmitted to the meeting room terminal 90 includes the original information, the reservation person can confirm the meeting name, the reservation person, the participant, or the like of the non-disclosure information by inputting the meeting identification information into the meeting room terminal 90. Further, it is preferred to display the name of the meeting, the reservation person, the participant, etc. of the non-disclosure information after the meeting is started. Therefore, it is also effective for the meeting room terminal 90 to receive the reservation information that is not made non-display or fixed notation as illustrated in FIG. 13.

### <Processing Meeting Room Terminal>

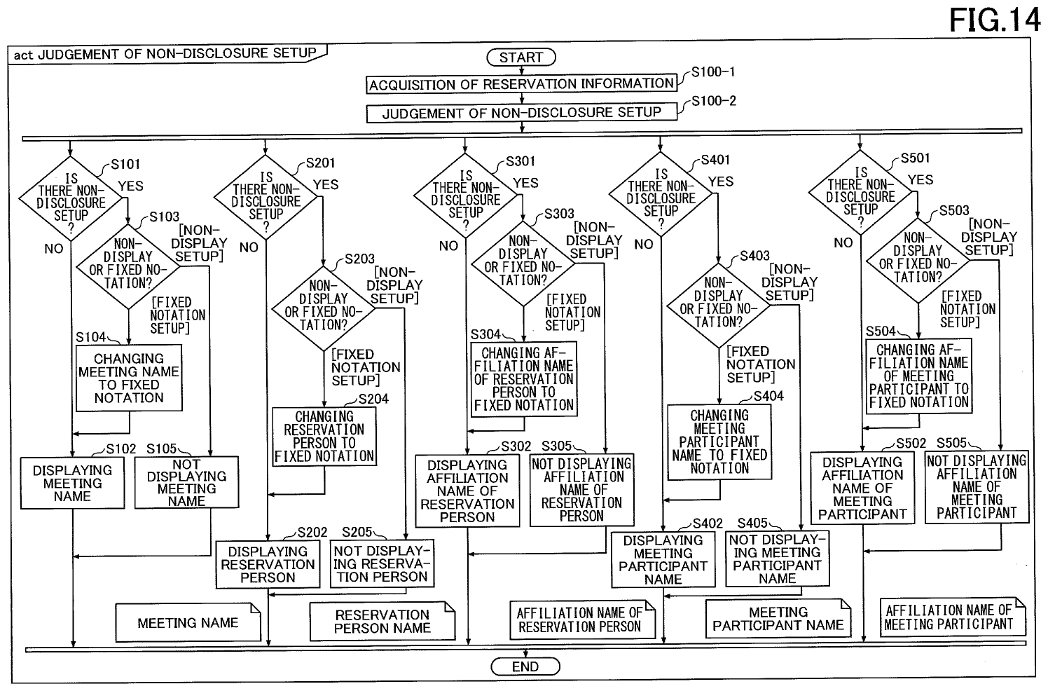

FIG. 14 is a flowchart illustrating an example of a procedure in which the meeting room terminal 90 displays the reservation information on the standby screen 501. The process of FIG. 14 is performed when the reservation information is displayed on the standby screen 501. Because the reservation information displayed on the standby screen 501 includes not only the most recent (next) reservation information but also the reservation information prospected for the day, the displayed reservation information is object to processing in FIG. 14.

First, the reservation information requesting unit 96 of the meeting room terminal 90 acquires the reservation information (S100-1). The display control unit 94 refers to the item of the non-disclosure setup of the reservation information (S100-2). Here, it is assumed that the reservation information is associated with the non-disclosure setup. The following processing takes place in parallel for each meeting name, reservation name, reservation name, participant name, and participant name. This may be done in series.

First, with regard to the meeting name, the display control unit 94 of the meeting room terminal 90 judges whether the meeting room is the non-disclosure target item (S101). When the determination of step S101 is No, the display control unit 94 displays the meeting name contained in the reservation information (S102).

When the determination of step S101 is Yes, the display control unit 94 determines whether the non-display method is non-display or fixed notation (S103).

When the non-disclosure method is a fixed notation, the display control unit 94 replaces the meeting name with a fixed notation (S104). When the non-disclosure method is not displayed, the display control unit 94 makes the meeting name non-disclosure (S105). The non-display means that the meeting name is displayed in empty characters.

In steps S201 to S205, the reservation person name is processed in a similar manner, in steps S301 to S305, the affiliation name of reservation person is processed in the same manner, in steps S401 to S405, the participant name is processed in a similar manner, and in steps S501 to S505, the affiliation name of the participant is processed in a similar manner.

### <Standby Screen>

The standby screen illustrated in FIG. 2 is supplemented. FIG. 2 illustrates an example of a standby screen 501 displayed by the meeting room terminal 90 when the meeting room is vacant but within a predetermined time until the start date and time of the next meeting starts. The standby screen 501 displays a current status field 561, a meeting room name field 562, a company name field 563, a start date and time field 564, an end date and time field 565, an room entry button 568, a subsequent reservation field 567, and so on.

The current status field 561 indicates current status of the meeting room at the current time. The display control unit 94 of the meeting room terminal 90 displays the status of the reservation information in the current status field 561. When there is no reservation information reserved at the current time, the display control unit 94 displays “vacancy” (until the next reservation can be checked in) or “ready for room entry” (after the next reservation can be checked in) in the current status field 561.

The name of the meeting room stored in the memory unit 99 is displayed in the meeting room name field 562. The meeting name field 563 represents the meeting name contained in the reservation information. When a check-in based on the next reservation is enabled, the display control unit 94 displays, makes non-display, or makes fix notation of the meeting name in accordance with the non-disclosure setup in the meeting name field 563.

The start date and time and the end date and time contained in the reservation information are respectively displayed in the start date and time field 564 and the end date and time field 565. Because FIG. 2 illustrates the standby screen enabling the check-in based on the next reservation, the start date and time field 564 and end date and time field 565 for the next meeting are displayed as the start date and time and end date and time of the next meeting.

The subsequent reservation field 567 indicates the start date and time and the end date and time of each meeting reserved later than the present time according to the reservation information. The entry button 568 is displayed when current status field 561 is “Ready for room entry”. The entry button 568 is a button for the user to check in. Pressing this button allows the reservation person to input the meeting identification information. The reservation person name field 570 may display the reservation person information or the non-display or fixed notation in response to non-disclosure setup.

In FIG. 2A, the participant name, the reservation person's affiliation name of reservation person, and the affiliation name of participant are not displayed, but if they are also displayed on the standby screen 501, the meeting room terminal 90 can make them non-disclosure.

### SUMMARY

As described above, in the resource reservation system according to this embodiment, because the meeting room terminal 90 displays the reservation information while making the items set to non-disclosure non-disclosure on the standby screen 501, the risk of unintentional leakage of the important information from the standby screen can be reduced.

### Second Embodiment

In the first embodiment, the meeting management server 30 performs a non-disclosure process in which the display content of the reservation information are changed and displayed. However, in this embodiment, a resource reservation system in which the meeting room terminal 90 performs a non-disclosure process will be described.

In this embodiment, the example of the system configuration of FIG. 3 and the example of the hardware configuration of FIG. 4 and FIGS. 5A and 5B will be adapted.

### <Function>

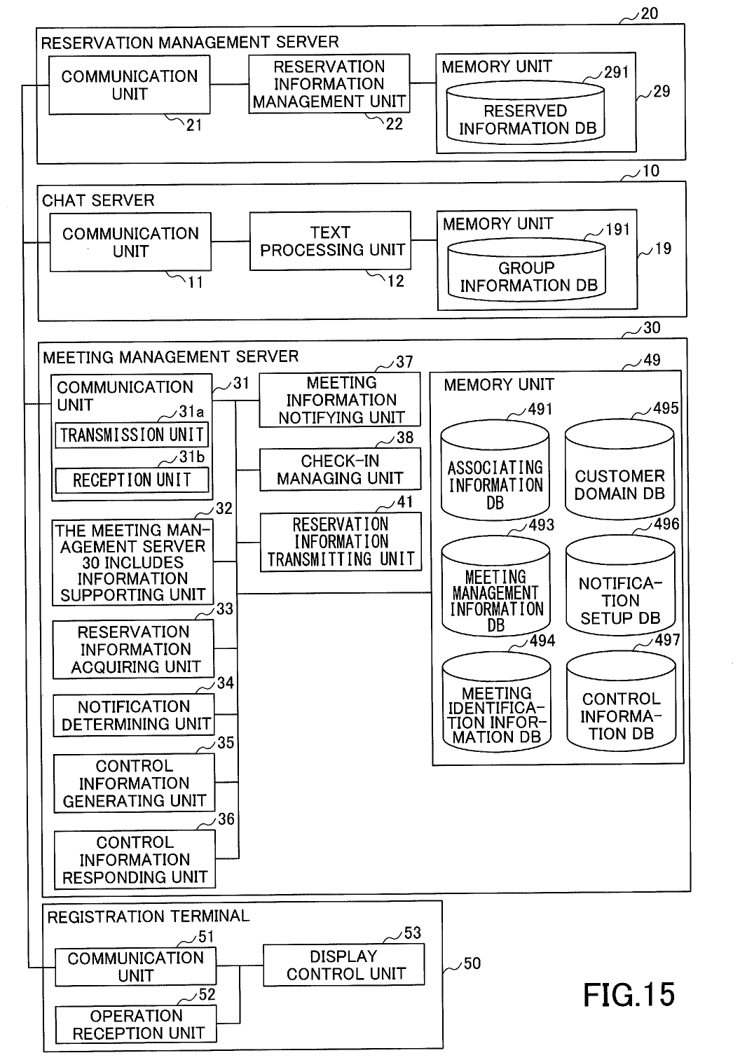

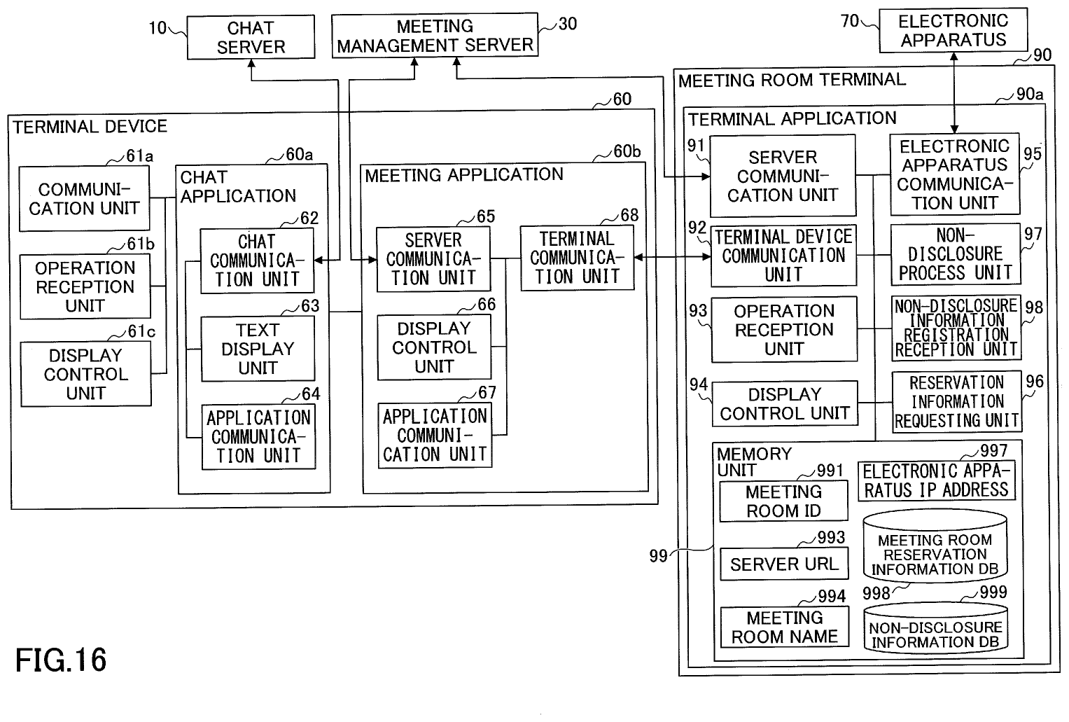

FIG. 15 is a functional block diagram of the example of the functions of the reservation management server 20, the chat server 10, the meeting management server 30, and the registration terminal 50 illustrated in a block shape. FIG. 16 is a functional block di an example of the functions of a terminal device and a meeting room terminal illustrated in a block shape. In FIGS. 15 and 16, the components having the same reference numerals as those in FIG. 6 perform the same functions, and therefore, only the main components of this embodiment may be described. First, the functions of the reservation management server 20, the chat server 10, the registration terminal 50, and the terminal device 60 may be the same as those of the first embodiment.

### <<Meetings Management Server>>

The meeting management server 30 according to this embodiment does not include the non-disclosure process unit 39 and the non-disclosure information registration reception unit 40. These functions are provided by the meeting room terminal 90.

### <<Meeting Room Terminal>>

The meeting room terminal 90 includes a non-disclosure process unit 97 and a non-disclosure information registration reception unit 98.

The non-disclosure process unit 97 performs a process of making the reservation information non-disclosure in accordance with the reservation information received from the meeting management server 30. First, there is a user-set priority mode, in which a process of making non-disclosure is performed only when the reservation information is set to non-disclosure (non-disclosure setup field in FIG. 8, non-disclosure flag in Table 1), and a forcible mode, in which the reservation information is forcibly made non-disclosure even when the reservation information is not set to non-disclosure (non-disclosure setup field in FIG. 8, non-disclosure flag in Table 1). These modes are previously set by the administrator. In the user setup priority mode, the non-disclosure process unit 97 determines whether the reservation information is set to non-disclosure (the non-disclosure setup field of FIG. 8 and the non-disclosure flag of FIG. 1 is ON). In the case of reservation information that is set to non-disclosure to the public, refer to Non-Disclosure Information DB 999 to determine whether the reservation information contains non-disclosure information. If it is contained, the relevant non-disclosure target items shall be non-display or fixed notation notation (non-disclosure setup) shall be created. In the case of forcible mode, even in the case of reservation information which is not set to non-disclosure, if the reservation information contains non-disclosure information by referring to the non-disclosure information DB 999, the item of the relevant reservation information shall be non-display or fixed notation notation (non-disclosure setup) shall be created. The reservation information with the non-disclosure setup added is stored in the meeting room reservation information DB 998.

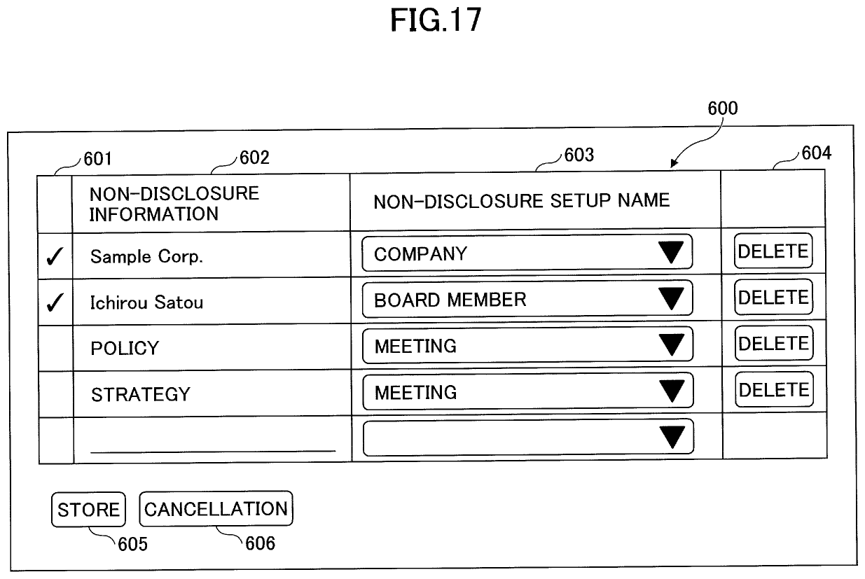

The non-disclosure information registration reception unit 98 displays the non-disclosure information management screen (FIGS. 17 to 19) which will be described later, and receives the registration of non-disclosure information from the administrator. The non-disclosure information for which the registration is received is stored in non-disclosure information DB 999.

The meeting room terminal 90 includes the meeting room reservation information DB 998 and the non-disclosure information DB 999 in the memory unit 99.

TABLE 10
RESERVATION INFORMATION

| | | NOTATION | AFFILIATION | | | START | END |
|---|---|---|---|---|---|---|---|
| | RESERVATION | NAME OF | NANE OF | MEET- | MEETING | DATE | DATE |
| RESERVATION | PERSON | RESERVATION | RESERVATION | ING | ROOM | AND | AND |
| ID | ACCOUNT | PERSON | PERSON | NAME | ID | TINE | TIME |
| 001 | a@xfood.com | Tarou | SALES | MEETING | K-001 | 2017 Jul. 7 | 2017 Jul. 7 |
| | | Tokkyo | DE- | ABOUT | | 10:00 | 12:00 |
| | | | PART- | AUTO- | | | |
| | | | MENT | MATED | | | |
| | | | | DRIVING | | | |
| | | | | WITH | | | |
| | | | | Sample | | | |
| | | | | Corp. | | | |
| 002 | e@xfood.oom | Ichirou | BOARD | DEVEL- | K-001 | 2017 Jul. 7 | 2017 Jul. 7 |
| | | Satou | MEM- | OPMENT | | 13:00 | 14:00 |
| | | | BER | | | | |
| | | | | OF COM- | | | |
| | | | | MERCIAL | | | |
| | | | | PRODUCT | | | |
| | | | | Y | | | |
| . . . | . . . | . . . | . . . | . . . | . . . | . . . | . . . |

| | PROSPECTIVE | NOTATION | AFFILIATION | NON- | NON- |
|---|---|---|---|---|---|
| RESERVATION | PARTICIPANT | NAME OF | NAME OF | DISCLOSURE | DISCLOSURE |
| ID | ACCOUNT | PARTICIPANT | PARTICIPANT | FLAG | SETUP |
| 001 | b@xfood.com | Tarou | DEVELOPMENT | ON | NON- |
| | | Jitsuyou | DEPARTMENT | | DISCLOSURE |
| | c@xfood.com | Tarou | PERSONNEL | | TARGET ITEN |
| | | Ishou | DEPARTMENT | | → MEETING |
| | d@xfood.com | Tarou | ACCOUNTING | | NAME |
| | | Shouhyou | DEPARTMENT | | NON-DISCLOSURE |
| | | | | | METHOD |
| | | | | | → NON- |
| | | | | | DISPLAY |
| 002 | f@xfood.com | Tarou | PURCHASE | ON | NON-DISCLOSURE |
| | | Chosaku | DEPARTMENT | | |
| | g@xfood.com | Tarou | PUBLIC | | TARGET ITEM |
| | | Fukyou | RELATIONS | | → RESER- |
| | | | DEPARTMENT | | VATION |
| | | | | | PERSON |
| | | | | | NON-DISCLOSURE |
| | | | | | METHOD |
| | | | | | → HYPHEN |
| . . . | . . . | . . . | . . . | . . . | . . . |

Table 10 is an example of the reservation information stored in the meeting room reservation information DB 998. Table 10 explains mainly the differences from the meeting management information DB 493 in Table 4. The meeting room reservation information DB 998 contains items that are set to non-disclosure. The item that is set to non-disclosure includes a non-disclosure target item and a non-disclosure method. These are based on the following non-disclosure information DB 999.

TABLE 11A

| NON- | NON- | NON- | NON- | TO BE |
|---|---|---|---|---|
| DISCLOSURE | DISCLOSURE | DISCLOSURE | DISCLOSURE | EXECUTED/ |
| INFORMATION | SETUP NAME | TARGET ITEM | METHOD | NOT |
| POLICY | MEETING | MEETING NAME | FIXED NOTATION | TRUE |
| | | | “MEETING” | |
| DETERMINATION | ARRANGEMENT | AFFILIATION OF | NON- | TRUE |
| | | PARTICIPANT | DISPLAY | |
| NEGOTIATION | EXTERNAL | PARTICIPANT NAME | FIXED NOTATION | TRUE |
| | MEETING | | “ASTERISK (*)” | |
| Sample Corp. | COMPANY | MEETING NAME | NON-DISPLAY | TRUE |
| Ichirou Satou | BOARD | RESERVATION PERSON | FIXED NOTATION | FALSE |
| | MEMBER | | “HYPHEN (-)” | |
| OO | GROUP | MEETING NAME | FIXED NOTATION | TRUE |
| STRATEGY | | | “REGULAR | |
| ROOM | | | CONFERENCE” | |
| | | RESERVATION PERSON | NON-DISPLAY | |
| OO | GROUP | MEETING NAME | FIXED NOTATION | TRUE |
| LICENSE | | | “REGULAR | |
| GROUP | | | CONFERENCE” | |
| | | RESERVATION PERSON | NON-DISPLAY | |
| PRESIDENT | BOARD | RESERVATION PERSON | FIXED NOTATION | TRUE |
| | MEMBER | | “HYPHEN (-)” | |
| GENERAL | DEPARTMENT | AFFILIATION NAME OF | FIXED NOTATION | FALSE |
| MANAGER | MANAGER | RESERVATION PERSON | “BLANK” | |
| DEPARTMENT | DEPARTMENT | AFFILIATION NAME OF | FIXED NOTATION | FALSE |
| MANAGER | MANAGER | RESERVATION PERSON | “BLANK” | |
| EXECUTIVE | BOARD | RESERVATION | FIXED NOTATION | FALSE |
| OFFICER | MEMBER | PERSON | “HYPHEN (-)” | |

TABLE 11B
OPERATION MODE SETUP INFORMATION

| | |
|---|---|
| OPERATION MODE | USER-SET PRIORITY MODE/FORCIBLE |

Table 11A indicates an example of the setups for non-disclosure information stored in non-disclosure information DB 999 (example of non-disclosure information memory means). First, the non-disclosure information DB 999 has items of non-disclosure information, a non-disclosure setup name, a non-disclosure target item, a non-disclosure methods, and to be executed/not. Non-disclosure information is information that is a target of non-disclosure if it is contained in the reservation information. They can be called a non-disclosure string or non-disclosure word. The non-disclosure setup name is the name of the non-disclosure setup regarding how to make the reservation information, in which non-disclosure information is found, non-disclosure. When the administrator selects a non-disclosure setup name for ease of operation, the non-disclosure target item and the non-disclosure method are decided. The non-disclosure target item indicate which item of the reservation information are made non-disclosure. The non-disclosure method indicates whether the non-disclosure information is fixed notation or non-display. Execute/not indicate whether the meeting management server 30 performs the process of rendering non-disclosure information non-disclosure. As described below, each of these setups can be performed by the administrator. If the non-disclosure method is fixed notation, the specific content of fixed notation is also set.

Table 11B indicates the operation mode setup information in which the user-set priority mode or the forcible mode is set. The administrator can previously set the user-set priority mode or the forcible mode. If the administrator does not set, the default operation mode is the forcible mode. This improves security.

The absence of the fixed notation information in Table 9B is due to the fact that the fixed notation is directly set in the reservation information in this embodiment.

In Table 11A, the non-disclosure target item and the non-disclosure method are associated in the non-disclosure information. However, if only the non-disclosure information is made non-disclosure, it is sufficient that the list of non-disclosure information may be registered. In addition, the meeting management server 30 may learn the information (company name, proper noun, title, etc.) that should be previously made non-disclosure in the machine learning and search the non-disclosure information by regarding the information as the non-disclosure information. In this case, there may not be present a list of non-disclosure information. Similarly, the meeting management server 30 may learn to correspond to the non-disclosure target items and non-disclosure methods in the non-disclosure information set by the administrator and apply the learning results to the unknown non-disclosure information.

### <Configuration of Non-Disclosure Information>

Next, a setup method of setting up the non-disclosure information will be described with reference to FIGS. 17 to 19. FIG. 17 indicates an example of a non-disclosure information management screen 600 displayed by the meeting room terminal 90. The non-disclosure information management screen 600 includes items of a check box field 601, a non-disclosure information field 602, a non-disclosure setup name field 603, and a deletion button 604.

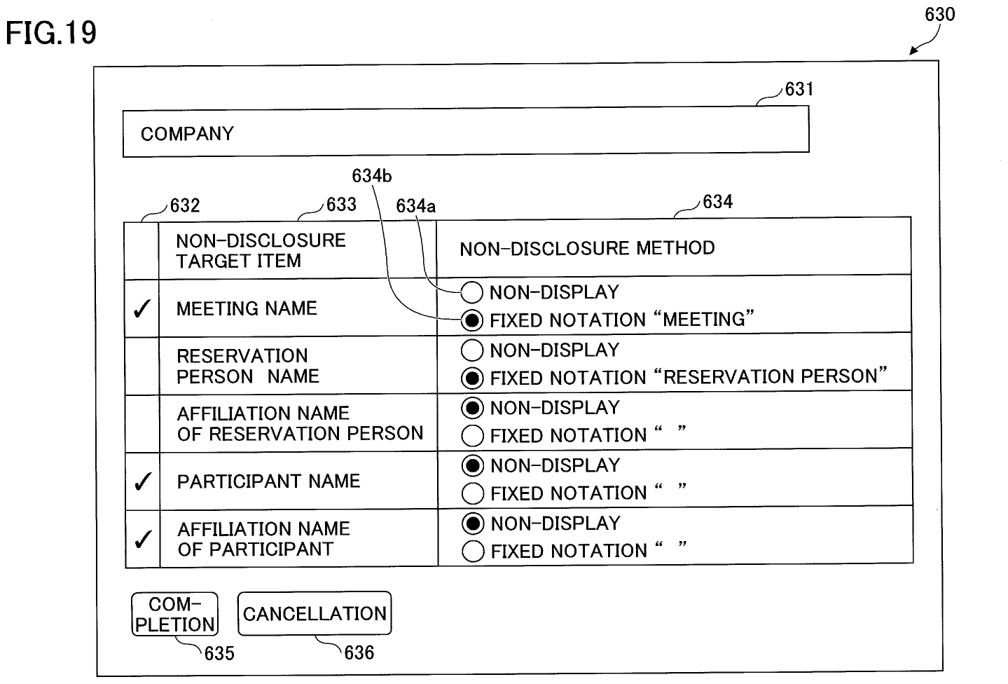

The non-disclosure information field 602 is information for searching all information contained in the reservation information. If the reservation information contains the same information as the non-disclosure information in the non-disclosure information field 602, the non-disclosure target item of the reservation information (see FIG. 19) will be made non-disclosure (non-display or fixed notation). When the operation mode is the forcible mode, the reservation information containing the same information as the non-disclosure information is made non-disclosure even when the non-disclosure setup field 405 is not checked on the reservation setup screen 400 of FIG. 8. This allows the reservation person to forget to check the non-disclosure setup field, but not to disclose the non-disclosure information can be made non-disclosure.

The non-disclosure setup name field 603 is the name of the non-disclosure setup. The administrator can easily set the non-disclosure target item and the non-disclosure target item by selecting the name of the non-disclosure setup. Said differently, a non-disclosure setup name can determine the non-disclosure target item and the non-disclosure method. The deletion button 604 is a button for the administrator to delete one record (a set of the check box, the non-disclosure information, and the non-disclosure setup name).

The check box field 601 is a field for setting whether to search for the corresponding non-disclosure information with the reservation information. That is, it can be set whether the non-disclosure setup of a single record is effective. The setup in the check box field 601 corresponds to “to be executed/not” in Table 11A.

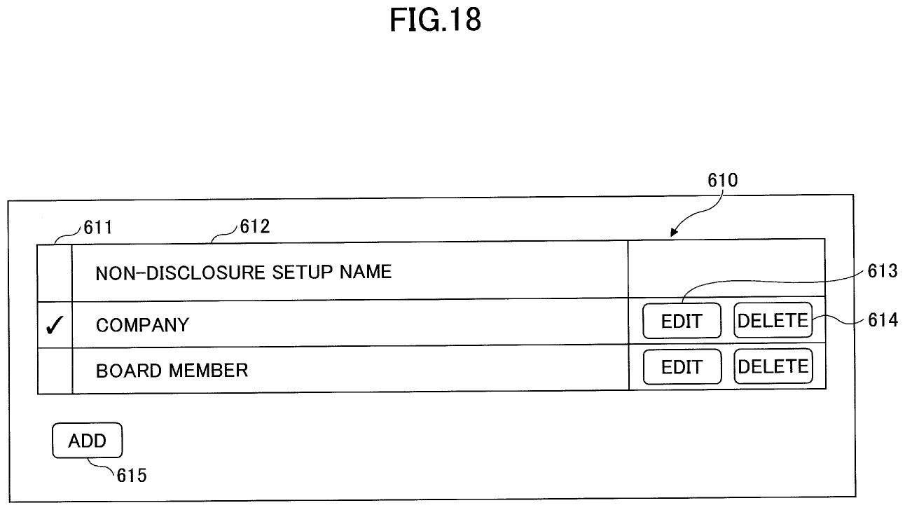

The bottom record of the non-disclosure information management screen 600 is blank, allowing the administrator to enter new non-disclosure information. When the non-disclosure setup name field 603 is pressed, the previously created non-disclosure setup name is displayed to be pulled down. Detailed setups of the non-disclosure setup are described with reference to FIGS. 18 and 19. When new non-disclosure information is input, a new blank record is added at the bottom of the non-disclosure information management screen 600.

The non-disclosure information management screen 600 includes a store button 605 and a cancel button 606. The store button 605 stores the edit state from the time when the registration terminal 50 opens to the time when the store button 605 is pressed on the non-disclosure information management screen 600. The cancel button 606 discards the edit state from when the non-disclosure information management screen 600 is opened until when the cancel button 606 is pressed.

FIG. 18 is an example of the non-disclosure setup management screen 610 displayed by the meeting room terminal 90. The non-disclosure setup management screen 610 is a screen on which the administrator edits or adds non-disclosure setup. The non-disclosure setup management screen 610 includes a check box field 611, a non-disclosure setup name field 612, an edit button 613, and a deletion button 614.

A check box field 611 is the field in which the administrator sets whether to use the non-disclosure setup in the non-disclosure setup name field 612. When check box field 611 is checked, non-disclosure setups become available, and when not checked, non-disclosure setups become unavailable.

Edit button 613 is a button for editing the content of the non-disclosure setup specified in non-disclosure setup name field 612. When the edit button 613 is pressed, a non-disclosure setup edit screen 630 of FIG. 19 is displayed. Delete button 614 is a button for deleting from non-disclosure setup management screen 610 the non-disclosure setups specified in non-disclosure setup name field 612.

In addition, the non-disclosure setup management screen 610 includes an add button 615. The add button 615 is provided to newly add a non-disclosure setup to the non-disclosure setup management screen 610 and display the non-disclosure setup on the non-disclosure setup management screen 610. When the add button 615 is pressed, the non-disclosure setup edit screen 630 of FIG. 19 is displayed.

FIG. 19 illustrates an example of a non-disclosure setup edit screen 630 displayed by the meeting room terminal 90. The non-disclosure setup edit screen 630 includes a non-disclosure setup name field 631, a check box field 632, a non-disclosure setup field 633, a non-disclosure method field 634, a completion button 635, and a cancellation button 636.

The non-disclosure setup name field 631 is a field for the administrator to edit the name when the non-disclosure setup is stored. If the administrator edits an existing non-disclosure setup, the non-disclosure setup name before the edition is displayed in advance. The non-disclosure target item field 633 lists the items of reservation information that can be made non-disclosure. All items contained in the reservation information and the information associated with the account may be the non-disclosure target item. For example, the meeting name, participant name, reservation person name, affiliation name of participant, affiliation name of reservation name, and so on can be selected. It is preferable that items that should not be made non-disclosure, such as the meeting start date and time and the meeting end date and time cannot be selected as the non-disclosure target item.

Because the administrator can arbitrarily select the non-disclosure target item in the non-disclosure target item field 633, not only the item containing non-disclosure information but also the item not containing non-disclosure information can be set to non-disclosure. In general, the item containing non-disclosure information should be made non-disclosure. Therefore, the item containing non-disclosure information may be set in the non-disclosure target item field.

The non-disclosure method field 634 is a field for the administrator to select whether to make non-display or fixed notation when the non-disclosure target item is made non-disclosure. The administrator may select a radio button 634a for non-display or a radio button 634b for fixed notation. When the administrator selects the radio button 634b for fixed notation, a specific fixed notation can be input.

The check box field 632 is a field for the administrator to set the combination of non-disclosure target item and the non-disclosure method to be used by the meeting room terminal 90 to set up non-disclosure. The administrator can make only an arbitrary item non-disclosure.

The completion button 635 is a button for storing the edit state from the time when the administrator opens the non-disclosure setup edit screen 630 until the completion button 635 is pressed. The cancellation button 636 is a button for discarding the edit state from the time when the administrator opens non-disclosure setup edit screen 630 until the time when the cancellation button 636 is pressed.

### <Operation Procedure>

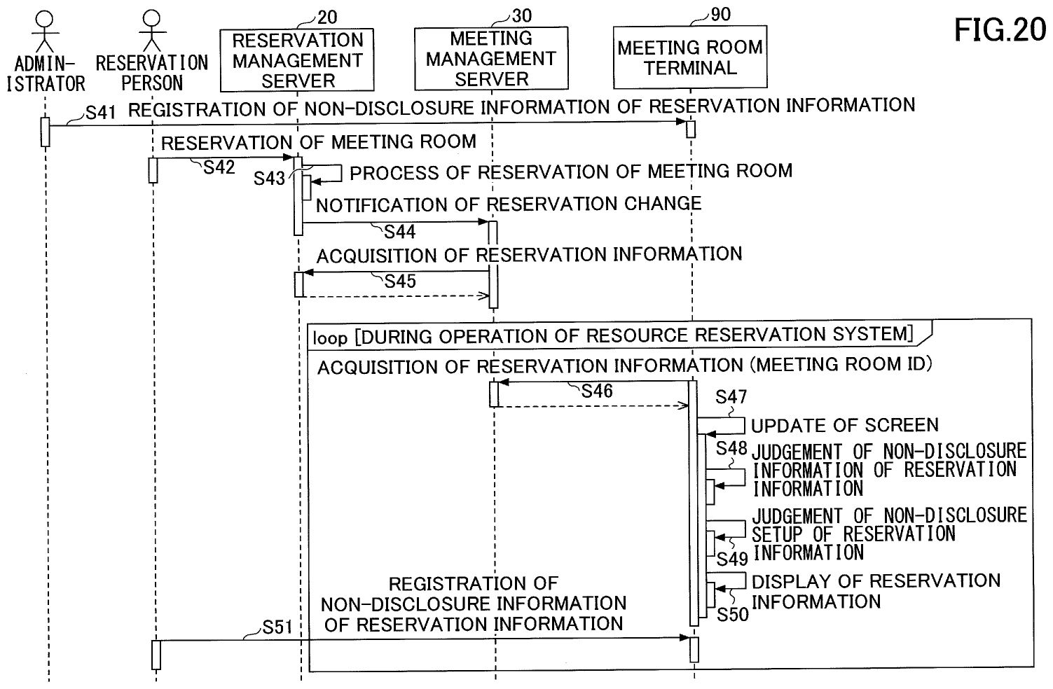

FIG. 20 is a sequence diagram illustrating an example of a procedure in which the meeting room terminal 90 makes the reservation information displayed on the standby screen 501 non-disclosure.

S41: The administrator operates the meeting room terminal 90 to display the screen illustrated in FIGS. 17 to 19. When the administrator sets the non-disclosure information or the like, the operation reception unit 93 receives the non-disclosure information, the non-disclosure setup name, the non-disclosure target item, the non-disclosure method, and to be executed/not (check box field 601) and registers them in the non-disclosure information DB 999.

S42: The reservation person reserves the meeting room to the reservation management server 20 at an arbitrary timing. That is, the reservation setup screen illustrated in FIG. 8 is displayed on the terminal device 60, and the reservation person enters the meeting name, the meeting start day, the meeting start date and time, the meeting end day, the meeting end date and time, the participant, the meeting room, and the non-disclosure setup. The operation reception unit 61b of the terminal device 60 receives this reservation information. The communication unit 61a transmits the reservation information to the reservation management server 20.

S43: The communication unit 21 of the reservation management server 20 receives the reservation information, and the reservation information management unit 22 registers the reservation information in the reservation information DB 291.

S44: The communication unit 21 of the reservation management server 20 notifies the meeting management server 30 that the reservation information has been updated by designating the account of the reservation person.

S45: The communication unit 31 of the meeting management server 30 receives an issue that the reservation information has been updated, and the reservation information acquiring unit 33 designates the account to the reservation management server 20, requests the reservation information, and acquires the reservation information. The reservation information may be designated by information specifying the reservation, such as the reservation ID, the meeting room name, and the reservation start date and time.

S46: The reservation information requesting unit 96 of the meeting room terminal 90 designates the meeting room ID to the meeting management server 30 at every predetermined time to request reservation information of the meeting room. Accordingly, when a predetermined time elapses from the registration of the reservation information, the meeting management server 30 acquires the reservation information.

S47: When the display control unit 94 of the meeting room terminal 90 acquires the reservation information from the meeting management server 30, the display control unit 94 starts an update process of the standby screen 501.

S48: The non-disclosure process unit 97 of the meeting room terminal 90 determines whether the non-disclosure information registered in the non-disclosure information DB 999 is contained in the reservation information. When the operation mode is the forcible mode, it is not necessary to judge whether the non-disclosure setup is checked (non-disclosure flag) at the time of judgment. When the operation mode is user-set priority mode, it is determined whether the non-disclosure information is contained in the reservation information only when the non-disclosure setup is checked (non-disclosure flag: ON).

S49: The non-disclosure process unit 97 of the meeting room terminal 90 performs the process to make the non-disclosure target item of the reservation information containing the non-disclosure information to be disclosed non-disclosure target items non-disclosure. That is, it creates the non-disclosure setup that contains the non-disclosure target item and a non-disclosure method to associate with the reservation information. Table 10 indicates the meeting room reservation information DB 998 as an example.

In the reservation information having the reservation ID=001, the meeting name is “Meeting about automated driving with Sample Corp.” and contains the non-disclosure information “Sample Corp.” in Table 11A. As Table 11A indicates that the non-disclosure target item is the meeting name and the non-disclosure method is made non-display, the non-disclosure setup of Table 10 is set as follows: “Non-disclosure target item to Meeting name; and Non-disclosure method to Non-display”

Reservation information having the reservation ID=002 indicates that the reservation person is “e@xfoof.com” whose notation name of the account is “Ichirou Satou”. “Ichirou Satou” is registered in the non-disclosure information in Table 11A. According to Table 11A, the non-disclosure target item is the reservation person and the non-disclosure method is fixed notation “hyphen”. Therefore, in Table 10, the non-disclosure setup is as follows. “Non-disclosure target item to Reservation person; Non-disclosure method Hyphen”

S50: The display control unit 94 of the meeting room terminal 90 determines whether each reservation information includes the non-disclosure setup. Based on the non-disclosure setup illustrated in Table 10, the display control unit 94 displays the non-disclosure target item displayed on the standby screen 501 in either non-display or fixed notation.

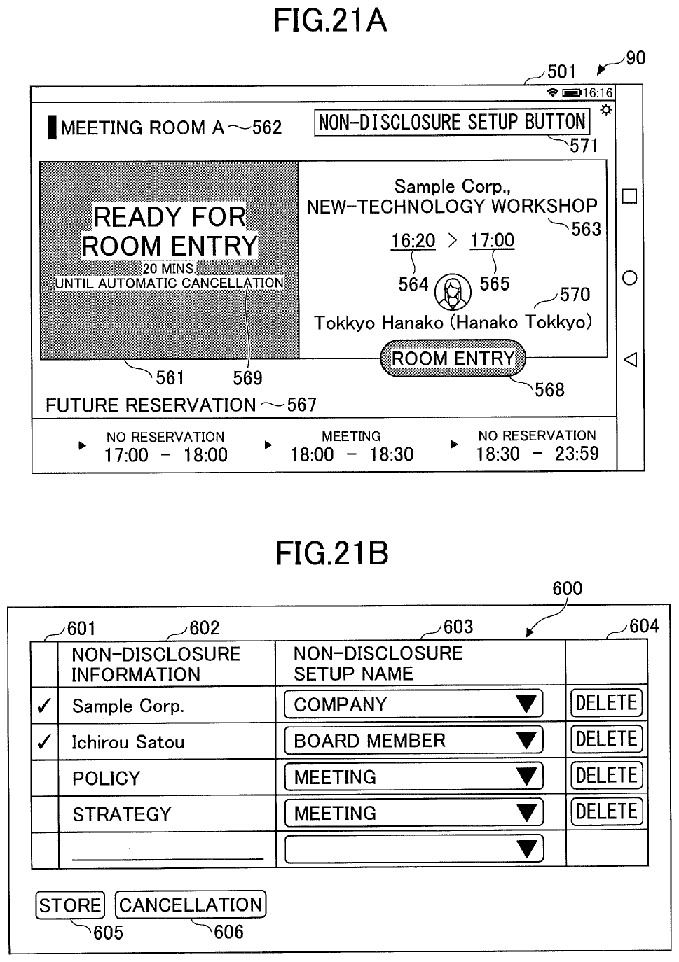

S51: The reservation person or participant can manually register non-disclosure information from the standby screen 501 displayed on the meeting room terminal 90. The process of step S11 will be described in FIG. 21.

Thereafter, the procedure in which the meeting room terminal 90 displays the reservation information on the standby screen 501 may be the same as that in FIG. 14 of the first embodiment.

### <When Non-Disclosure Information is Displayed>

Although the meeting room terminal 90 has performed the process of associating the non-disclosure setup with the reservation information as described in FIG. 20, the information that should not be disclosed may be displayed. In this case, the reservation person or participant can make an arbitrary item of the reservation information non-disclosure. An explanation will be given with reference to FIG. 21. FIG. 21 is an example of explaining an operation of making the arbitrary item of the reservation information non-disclosure.

FIG. 21A is a standby screen 501 similar to FIG. 2, and the standby screen 501 includes a non-disclosure setup button 571. The non-disclosure setup button 571 is a button (display part) for displaying the non-disclosure information management screen 600 illustrated in FIG. 17. When the reservation person or participant presses the non-disclosure setup button 571, the meeting room terminal 90 displays the non-disclosure information management screen 600, as illustrated in FIG. 21B. This allows the reservation person or administrator to register non-disclosure information from the meeting room terminal 90. Then, when the screen is transited in a manner similar to FIGS. 18 and 19, the non-disclosure target item and the non-disclosure method can be registered. Accordingly, the reservation person or administrator may immediately register arbitrary non-disclosure information to make the arbitrary item of the reservation information non-disclosure.

Further, because the operation reception unit 93 registers the received the non-disclosure target item, the non-disclosure method, and the non-disclosure information (for example, the meeting name, the reservation person, the participant, the affiliation name of the reservation person, and all or part of the affiliation name of the participant) in the non-disclosure information DB 999 of the meeting room terminal 90, the reservation information to be displayed in the future can be maintained to be noon-disclosure if the same non-disclosure information is contained.

Here, the meeting room terminal 90 may authenticate the reservation person or participant before accepting the setup of non-disclosure information. For example, if the non-disclosure setup edit screen 630 is displayed only when the meeting identification information is correct, it can be prevented that the reservation information from being intentionally non-disclosure.

### <Standby Screen>

The standby screen illustrated in FIG. 21A is supplemented. FIG. 21A illustrates an example of a standby screen 501 displayed by the meeting room terminal 90 when the meeting room is vacant within a predetermined time until the start date and time of the next meeting. The standby screen 501 displays a current status field 561, a meeting room name field 562, a company check box field 601name field 563, a start date and time field 564, an end date and time field 565, an room entry button 568, and a subsequent reservation field 567.

The current status field 561 indicates the current status of the meeting room. The display control unit 94 of the meeting room terminal 90 displays the status of the reservation information in the current status field 561. When there is no reservation information reserved at the current time, the display control unit 94 displays “vacancy” (until the check-in of the next reservation is enabled) or “ready for room entry” (after check-in of the next reservation is enabled) in the current status field 561.

The name of the meeting room 994 stored in the memory unit 99 is displayed in the meeting room name field 562. The meeting name field 563 represents the meeting name contained in the reservation information. When a check-in based on the next reservation is enabled, the display control unit 94 displays, and make the meeting name non-display or fixated notation in accordance with the non-disclosure setup in the meeting name field 563.

The start date and time and the end date and time contained in the reservation information are respectively displayed in the start date and time field 564 and the end date and time field 565. Because FIG. 21A is the standby screen enabled to check in based on the next reservation, the next start date and time and the next end date and time respectively correspond to the start date and time field 564 and the end date and time field 565.

The subsequent reservation field 567 indicates the start date and time and the end date and time of each meeting reserved later than the present according to the reservation information. The room entry button 568 is displayed when current status field 561 is “Ready for room entry”. The room entry button 568 is a button for the user to check in. Clicking this button allows the reservation person to input the meeting identification information. The reservation person name field 570 may be displayed to indicate the reservation person information, may be made non-display, or may be displayed to indicate fixed notation depending on the non-disclosure setup.

In FIG. 21A, the participant name, the affiliation name of the reservation person, and the affiliation name of the participant are not displayed. However, if these are also displayed on the standby screen 501, the meeting room terminal 90 can be made non-disclosure.

### Summary

As described above, in the resource reservation system according to this embodiment, because the meeting room terminal 90 displays the reservation information by making the items set to non-disclosure on the standby screen 501 non-disclosure, the risk of unintentional leakage of the important information from the standby screen can be reduced.

### Third Embodiment

In the second embodiment, although the meeting room terminal 90 searches the non-disclosure information from the reservation information and makes the non-disclosure information contained in the reservation information non-disclosure, the meeting management server 30 (the cloud side) may associate the reservation information with the non-disclosure setup. Both the meeting room terminal 90 and the meeting management server 30 may perform accordingly. In this embodiment, the resource reservation system 100 for performing a non-disclosure process by both the meeting room terminal 90 and the meeting management server 30 will be described.

In this embodiment, a system configuration of FIG. 3 and a hardware configuration of FIGS. 4 and 5 will be described with reference to this embodiment.

<Function>

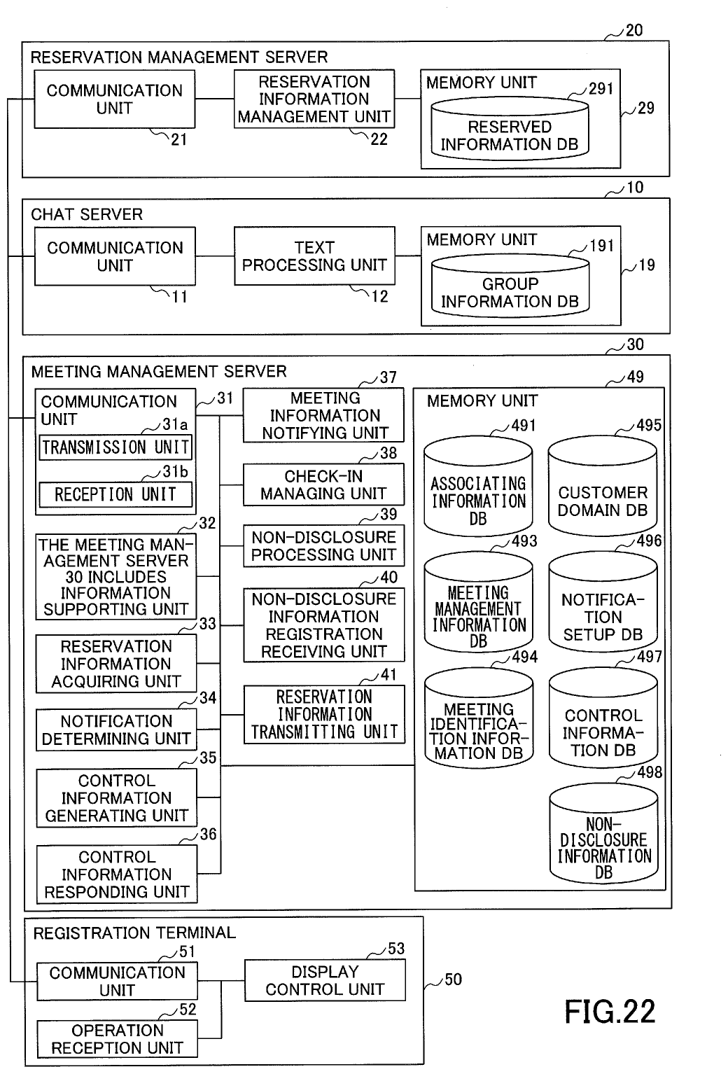

FIG. 22 is a functional block diagram of an example of the function of the reservation management server 20, the chat server 10, the meeting management server 30, and the registration terminal 50 illustrated in a block shape. The description of FIG. 22 mainly explains the difference from FIG. 15.

In the functional block diagram of FIG. 22, the meeting management server 30 includes a non-disclosure process unit 39 and a non-disclosure information registration reception unit 40. These functions may be the same as those of the non-disclosure process unit 39 and the non-disclosure information registration reception unit 40 (or the non-disclosure process unit 97 and the non-disclosure information registration reception unit 98 described in FIG. 16) described in FIG. 6. However, the non-disclosure information registration reception unit 40 provides a web application for receiving registration of non-disclosure information from the registration terminal 50. That is, the screen information of the screen of FIGS. 17 to 19 is generated and transmitted to the registration terminal 50 through the communication unit 31, and the registration terminal 50 receives the registration concerning the non-disclosure information. The registered non-disclosure information is stored in the non-disclosure information DB 498 of the meeting management server. The screen information is prepared by HTML, CSS (Cascade Style Sheet) and JavaScript (trademark).

Further, the non-disclosure information DB 498 is constructed in the memory unit 49. The configuration of non-disclosure information DB 498 ay be similar to Table 11. By registering non-disclosure information different from the non-disclosure information DB 999 of the meeting room terminal 90 in the non-disclosure information DB 498, the information that should not be disclosed can be easily made non-disclosure.

The functional block diagram of the meeting room terminal 90 may be the same as that of FIG. 16. Accordingly, the administrator can register information about non-disclosure information in the meeting management server 30 and the meeting room terminal 90. Also, as illustrated in FIG. 21, the reservation person or participant can register information about non-disclosure information in the meeting room terminal 90.

### <About Reservation Information>

In this embodiment, the non-disclosure setup is registered in the meeting management information DB 493 in order to associate the non-disclosure setup with the reservation information in the meeting management server 30.

TABLE 12
MEETING MANAGEMENT INFORMATION

| | | NOTATION | AFFILIATION | | | START | END |
|---|---|---|---|---|---|---|---|
| | RESERVATION | NAME OF | NAME OF | | MEETING | DATE | DATE |
| RESERVATION | PERSON | RESERVATION | RESERVATION | MEETING | ROOM | AND | AND |
| ID | ACCOUNT | PERSON | PERSON | NAME | ID | TIME | TIME |
| 001 | a@xfood.com | Tarou | SALES | MEETING | K-001 | 2017 | 2017 |
| | | Tokkyo | DEPART- | ABOUT | | Jul. 7 | Jul. 7 |
| | | | MENT | AUTO- | | 10:00 | 12:00 |
| | | | | MATED | | | |
| | | | | DRIVING | | | |
| | | | | WITH | | | |
| | | | | Sample | | | |
| | | | | Corp. | | | |
| 002 | e@xfood.com | Ichirou | BOARD | DEVEL- | K-001 | 2017 | 2017 |
| | | Satou | MEM- | OPMENT | | Jul. 7 | Jul. 7 |
| | | | BER | OF COM- | | 13:00 | 14:00 |
| | | | | MERCIAL | | | |
| | | | | PRODUCT | | | |
| | | | | Y | | | |
| . . . | . . . | . . . | . . . | . . . | . . . | . . . | . . . |

| | | | | | | NON- |
|---|---|---|---|---|---|---|
| | | | | | | DISCLOSURE |
| | PROSPECTIVE | NOTATION | AFFILIATION | | NON- | SETUP |
| RESERVATION | PARTICIPANT | NAME OF | NAME OF | | DISCLOSURE | (CREATED |
| ID | ACCOUNT | PARTICIPANT | PARTICIPANT | STATUS | FLAG | BY SERVER) |
| 001 | b@xfood.com | Tarou | DEVELOP- | ALREADY | ON | NON- |
| | | Jitsuyou | MENT | CHECKED | | DISCLOSURE |
| | | | DEPART- | IN | | TARGET |
| | | | MENT | | | ITEM |
| | c@xfood.com | Tarou | PER- | | | → MEETING |
| | | Ishou | SONNEL | | | NAME |
| | | | DEPART- | | | NON- |
| | | | MENT | | | DISCLOSURE |
| | d@xfood.com | Tarou | ACCOUN- | | | METHOD |
| | | Shouhyou | TING | | | → NON- |
| | | | DEPART- | | | DISPLAY |
| | | | MENT | | | |
| 002 | f@xfood.com | Tarou | PUR- | ALREADY | ON | NON- |
| | | Chosaku | CHASE | NOTI- | | DISCLOSURE |
| | | | DEPART- | FIED | | TARGET |
| | | | MENT | | | ITEM |
| | g@xfood.com | Tarou | PUBLIC | | | → RESER- |
| | | Fukyou | RELA- | | | VATION |
| | | | TIONS | | | PERSON |
| | | | DEPART- | | | NON- |
| | | | MENT | | | DISCLOSURE |
| | | | | | | METHOD |
| | | | | | | → HYPHEN |
| . . . | . . . | . . . | . . . | . . . | . . . | . . . |

Table 12 indicates the meeting management information stored in the meeting management information DB 493 stored in the meeting management server 30. The description in Table 12 mainly explains the differences from Table 4. In order for the non-disclosure process unit 39 of the meeting management server 30 to be associated with the non-disclosure setup to the reservation information, the meeting management information DB 493 has items of non-disclosure setup (non-disclosure setup (created by server)).

TABLE 13
RESERVATION INFORMATION

| | | NOTATION | AFFILIATION | | | START | END | |
|---|---|---|---|---|---|---|---|---|
| | RESERVATION | NAME OF | NAME OF | | MEETING | DATE | DATE | PROSPECTIVE |
| RESERVATION | PERSON | RESERVATION | RESERVATION | MEETING | ROOM | AND | AND | PARTICIPANT |
| ID | ACCOUNT | PERSON | PERSON | NAME | ID | TIME | TIME | ACCOUNT |
| 001 | a@xfood.com | Tarou | SALES | MEETING | K-001 | 2017 | 2017 | b@xfood.com |
| | | Tokkyo | DEPART- | ABOUT | | Jul. 7 | Jul. 7 | |
| | | | MENT | AUTO- | | 10:00 | 12:00 | |
| | | | | MATED | | | | |
| | | | | DRIVING | | | | c@xfood.com |
| | | | | WITH | | | | |
| | | | | Sample | | | | |
| | | | | Corp. | | | | |
| | | | | | | | | d@xfood.com |
| 002 | e@xfood.com | Ichirou | BOARD | DEVEL- | K-001 | 2017 | 2017 | f@xfood.com |
| | | Satou | MEM- | OPMENT | | Jul. 7 | Jul. 7 | |
| | | | BER | OF COM- | | 13:00 | 14:00 | |
| | | | | MERCIAL | | | | |
| | | | | PRODUCT | | | | g@xfood.com |
| | | | | Y | | | | |
| . . . | . . . | . . . | . . . | . . . | . . . | . . . | . . . | . . . |

| | | | | | NON- |
|---|---|---|---|---|---|
| | | | | NON- | DISCLOSURE |
| | | | | DISCLOSURE | SETUP |
| | NOTATION | AFFILIATION | NON- | SETUP | (CREATED BY |
| RESERVATION | NAME OF | NAME OF | DISCLOSURE | (CREATED BY | MEETING ROOM |
| ID | PARTICIPANT | PARTICIPANT | FLAG | SERVER) | TERMINAL) |
| 001 | Tarou | DEVELOPMENT | ON | NON- | NON- |
| | Jitsuyou | DEPARTMENT | | DISCLOSURE | DISCLOSURE |
| | | | | TARGET ITEM | TARGET ITEM |
| | | | | → MEETING | → MEETING |
| | Tarou | PERSONNEL | | NAME | NAME |
| | Ishou | DEPARTMENT | | NON- | NON- |
| | | | | DISCLOSURE | DISCLOSURE |
| | | | | METHOD | METHOD |
| | Tarou | ACCOUNTING | | → NON- | → NON- |
| | Shouhyou | DEPARTMENT | | DISPLAY | DISPLAY |
| 002 | Tarou | PURCHASE | ON | NON- | NON- |
| | Chosaku | DEPARTMENT | | DISCLOSURE | DISCLOSURE |
| | | | | TARGET ITEM | TARGET ITEM |
| | | | | → RESER- | → RESER- |
| | Tarou | PUBLIC | | VATION | VATION |
| | Fukyou | RELATIONS | | PERSON | PERSON |
| | | DEPARTMENT | | NON- | NON- |
| | | | | DISCLOSURE | DISCLOSURE |
| | | | | METHOD | METHOD |
| | | | | → HYPHEN | → HYPHEN |
| . . . | . . . | . . . | . . . | . . . | . . . |

Table 13 indicates the meeting management information stored in the meeting room reservation information DB 998 stored in the meeting room terminal 90. Table 13 explains mainly the differences from Table 10. In addition to the non-disclosure setup created by the non-disclosure process unit 39 of the meeting management server 30, two non-disclosure setups (non-disclosure setups (created by the server) and (non-disclosure setups (created by the meeting room terminal server)) are associated with the reservation information in order for the non-disclosure process unit 97 of the meeting room terminal 90 to be associated with the reservation information.

The display control unit 94 of the meeting room terminal 90 performs a process of making the reservation information of the standby screen non-disclosure based on each of the two non-disclosure setups of the reservation information of Table 13. In Table 13, for ease of illustration, the two non-disclosure setups are the same, but if the meeting management server 30 and the meeting room terminal 90 differ in either the non-disclosure information, the non-disclosure target item, or the non-disclosure method, the different non-disclosure setups can be associated with the reservation information on the meeting room terminal 90 and the meeting management server 30. Thus, reservation information is double-checked, making it easier for information, which should be non-disclosure, non-disclosure.

### <Operation Procedure>

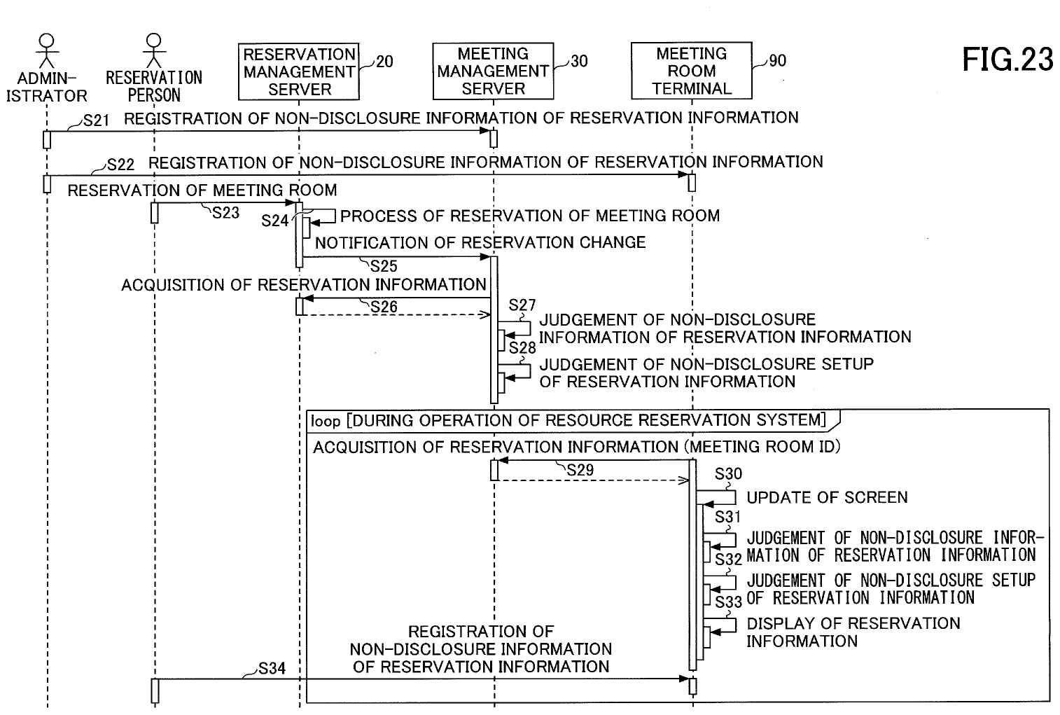

FIG. 23 is a sequence diagram of an example of a procedure in which the meeting room terminal 90 releases the reservation information displayed on the standby screen 501.

S21: The administrator operates the registration terminal 50 to communicate the registration terminal 50 with the meeting management server 30. The non-disclosure information registration reception unit 40 of the meeting management server 30 transmits screen information of the screen illustrated in FIGS. 17 to 19 to the registration terminal 50 as a web application. The communication unit 51 of the registration terminal 50 receives screen information, and the display control unit 53 of the registration terminal 50 displays the screen illustrated in FIGS. 17 to 19. When the administrator sets the information regarding the non-disclosure information, the operation reception unit 52 receives the non-disclosure information, the non-disclosure setup name, the non-disclosure target item, the non-disclosure method, and to be executed/not (the check box field 601), and the communication unit 51 transmits them to the meeting management server 30. The non-disclosure information registration reception unit 40 of the meeting management server 30 registers these in the non-disclosure information DB 498 of the meeting management server 30.

S22: The administrator operates the meeting room terminal 90 to display the screen illustrated in FIGS. 17 to 19. When the administrator sets the information regarding the non-disclosure information, the operation reception unit 93 receives the non-disclosure information, the non-disclosure setup name, the non-disclosure target item, the non-disclosure method, and to be executed/not (the check box field 601), and the operation reception unit 93 registers the non-disclosure information DB 999 of the meeting room terminal 90 in the check box field 601.

It may be similar to steps S2 to S5 in FIG. 20.

S27: The non-disclosure process unit 39 of the meeting management server 30 determines whether the non-disclosure information registered in the non-disclosure information DB 498 is contained in the reservation information. When the operation mode is forcible, it is not necessary to judge whether the non-disclosure setup is checked (non-disclosure flag) at the time of judgment. When the operation mode is the user-set priority mode, it is determined whether the non-disclosure information is contained in the reservation information only when the non-disclosure setup is checked (non-disclosure flag: ON).

S28: The non-disclosure process unit 39 of the meeting management server 30 performs the process to make the non-disclosure target item of the reservation information containing the non-disclosure information non-disclosure. Said differently, a non-disclosure method is created for each non-disclosure target item and the non-disclosure setup is associated with the reservation information. This creates the meeting management information in Table 12.

S29 to S32: these steps may be the same as steps S6 to S9 in FIG. 20. This creates the meeting management information in Table 13.

S33: The display control unit 94 of the meeting room terminal 90 judges whether one or more non-disclosure setups are contained for each reservation information. There may be zero, one, or two non-disclosure setups. The display control unit 94 displays the non-disclosure target item displayed on the standby screen 501 in non-display or fixed notation based on the reservation information as indicated in Table 13.

S34: The reservation person or participant can manually set to non-disclosure from the standby screen displayed by the meeting room terminal 90.

In this embodiment, both the meeting management server 30 and the meeting room terminal 90 set the reservation information to non-disclosure. Only the meeting management server 30 may perform the process in which the reservation information is made non-disclosure.

### Summary

Therefore, according to the resource reservation system according to this embodiment, not only the meeting room terminal 90 but also the meeting management server performs a process of making the non-disclosure information non-disclosure, in addition to the effect of the first and second embodiments, thereby making it easier to make the information that should not be disclosed non-disclosure. For example, the administrator may configure the meeting management server 30 with common non-disclosure information in each meeting room and register the meeting room with individual non-disclosure information in the meeting room terminal 90.

### <Other Applications>

While the preferred embodiment of the present invention has been described with reference to examples, various modifications and substitutions may be made thereto without departing from the spirit and scope of the invention.

For example, it is described that although the administrator registers the non-disclosure information, the meeting management server 30 may automatically detect the non-disclosure information from the information. In this case, the meeting management server 30 learns the information that should not be disclosed by machine learning in advance and searches the non-disclosure information as the non-disclosure information.

A plurality of the meeting management servers 30 may exist, or the functions of the meeting management servers 30 may be distributed among a plurality of servers. The reservation management server 20 and the meeting management server 30 may be integrated.

The resource reservation system 100 of this embodiment may also be referred to as a Web service. Web services are a variety of services provided through the application of Internet-related technology. Examples include meeting room rental services and various rental services. A system that uses Web services is called a system that uses Web services.

Further, a configuration example such as FIGS. 6 and 7 illustrated in the above-described embodiment is divided according to the main functions for easier understanding of the process of the resource reservation system 100. However, the present invention is not limited by the method of dividing or the name of each treatment unit. The resource reservation system 100 may be divided into more processing units depending on the processing content. Alternatively, one processing unit can be split to include more processes.

The functions of the embodiments described above may be implemented by one or more processing circuits (i.e., a circuitry). As used herein, a “processing circuit” includes a processor programmed to perform each function by software, such as a processor implemented in electronic circuits, an ASIC (Application Specific Integrated Circuit) designed to perform each function as described above, a digital signal processor (DSP), a field programmable gate array (FPGA), or a conventional circuit module.

The non-disclosure information DB 498 is an example of a non-disclosure information memory means, the non-disclosure process unit 39 is an example of a non-disclosure process means, and the communication unit 31 is an example of a transmission means.

A resource reservation system that can change at least a part of information displayed by an information processing terminal can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although a resource reservation system has been described in detail, it should be understood that various changes, substitutions, and alterations could be made thereto without departing from the spirit and scope of the invention.

What is claimed is:

1. A resource reservation system comprising:
a hardware server including at least one information processing apparatus that stores reservation information concerning at least one resource; and
a hardware information processing terminal that acquires and displays the reservation information from the hardware server,
wherein the hardware information processing terminal is installed for each of the at least one resource and displays a display content of the reservation information modified in accordance with setup information that sets a display method for displaying the reservation information.

2. The resource reservation system according to claim 1,
wherein the hardware information processing terminal displays the reservation information,
wherein at least a portion of the reservation information acquired from the hardware server is made non-disclosure in response to the setup information.

3. The resource reservation system according to claim 1,
wherein the hardware information processing terminal displays the setup information in which at least a portion of the reservation information obtained from the hardware server is changed to non-display or fixed notation.

4. The resource reservation system according to claim 1,
wherein the setup information contains a reservation information item of the reservation information that is changed and then display.

5. The resource reservation system according to claim 1,
wherein the setup information contains an issue that the reservation information is made non-disclosure or is changed to fixed notation.

6. The resource reservation system according to claim 1,
wherein the setup information indicates that an item of the meeting name contained in the reservation information is made non-disclosure, and
wherein the hardware information processing terminal makes the meeting name set in the item of the meeting name non-disclosure.

7. The resource reservation system according to claim 1,
wherein the setup information indicates that a reservation person name item contained in the reservation information is made non-disclosure, and
wherein the hardware information processing terminal makes a reservation person name set in the reservation person name item non-disclosure.

8. The resource reservation system according to claim 1,
wherein the setup information indicates that a participant name item contained in the reservation information is made non-disclosure, and
wherein the hardware information processing terminal makes a participant name set in the participant name item non-disclosure.

9. The resource reservation system according to claim 1,
wherein the setup information indicates that a reservation person affiliation name item contained in the reservation information is made non-disclosure, and
wherein the hardware information processing terminal makes a reservation person affiliation name set in the reservation person affiliation name item non-disclosure.

10. The resource reservation system according to claim 1, wherein the setup information indicates that a participant affiliation name item contained contained in the reservation information is made non-disclosure, and
wherein the hardware information processing terminal makes a participant affiliation name set in the participant affiliation name item non-disclosure.

11. The resource reservation system according to claim 1,
wherein the hardware server includes
a memory performing as a non-disclosure information memory means for storing non-disclosure information to be made non-disclosure, and
a circuitry performing as a non-disclosure processing means for creating, when the reservation information contains the non-disclosure information stored in the non-disclosure information memory means, the setup information.

12. The resource reservation system according to claim 11,
wherein the non-disclosure information stored by the non-disclosure information memory means is associated with a meeting room.

13. The resource reservation system according to claim 1,
wherein the hardware information processing terminal makes the predetermined non-disclosure information contained in the reservation information received from the hardware server non-disclosure.

14. The resource reservation system according to claim 13,
wherein the hardware information processing terminal refers to a memory performing as a non-disclosure information memory means that stores the non-disclosure information in association with a non-disclosure target item to be made non-disclosure from among items of the reservation information so as to make the non-disclosure target item associated with the non-disclosure information contained in the reservation information received from the hardware server.

15. The resource reservation system according to claim 14,
wherein the hardware information processing terminal receives registration of the non-disclosure information.

16. The resource reservation system according to claim 15,
wherein the hardware information processing terminal receives an association between the non-disclosure information and the non-disclosure target item and registers the association in the memory performing as the non-disclosure information memory means.

17. The resource reservation system according to claim 15,
wherein the hardware information processing terminal displays a display component which receives registration of the non-disclosure information on the screen on which the reservation information is displayed.

18. The resource reservation system according to claim 14,
wherein the hardware information processing terminal makes, when the non-disclosure target item is an item of the meeting name contained in the reservation information, a meeting name set in a meeting name field non-disclosure.

19. An information display method that is performed by a resource reservation system including a server system including an information processing apparatus that stores reservation information for at least one resource, and an information processing terminal that acquires and displays the reservation information from the server system,
the information display method comprising:
installing the information processing terminal for each of the at least one resource; and
displaying a display content of the reservation information modified in accordance with the setup information that sets a display method for displaying the reservation information.

20. A server system including at least one hardware information processing apparatus that transmits reservation information concerning at least one resource to an hardware information processing terminal through a network, the server system comprising:
a memory performing as a non-disclosure information memory means for storing non-disclosure information that is to be made non-disclosure; and
a circuitry
performing as, a non-disclosure processing means for creating, when the reservation information contains the non-disclosure information stored in the non-disclosure information memory means, the setup information in which a display method for displaying the reservation information is set, and also performing as
also performing as a transmission means for transmitting the reservation information and the setup information to the hardware information processing terminal.
